(19) United States
(12) Patent Application Publication
(10) Pub. No.: US 2025/0281923 A1
(43) Pub. Date: Sep. 11, 2025

(54) Pipette Tip and Method for Producing Concentrated Solution Using Same

(71) Applicants: VALQUA, LTD., Tokyo (JP); National Institute of Advanced Industrial Science and Technology, Tokyo (JP); Precision System Science Co., Ltd., Matsudo-shi (JP)

(72) Inventors: Atsushi Kuno, Tsukuba-shi (JP); Takashi Sato, Tsukuba-shi (JP); Hirotaka Muto, Machida-shi (JP); Yukino Yoshida, Machida-shi (JP); Yuji Kanai, Machida-shi (JP); Hideji Tajima, Matsudo-shi (JP); Kazumi Sawakami, Matsudo-shi (JP); Kazuhiro Nakamura, Matsudo-shi (JP); Osamu Segawa, Matsudo-shi (JP)

(21) Appl. No.: 19/073,502

(22) Filed: Mar. 7, 2025

(30) Foreign Application Priority Data
Mar. 8, 2024 (JP) 2024-036061
Dec. 27, 2024 (JP) 2024-232677

(51) Int. Cl. B01L 3/02

(52) U.S. Cl. CPC B01L 3/0275; B01L 2200/0647; B01L 2300/0681

(57) ABSTRACT

One aspect of the present invention relates to a pipette tip capable of repeatedly dispersing a carrier in the tip by suction and discharge, and capable of producing a concentrated solution having a small dead volume and having increased concentration of a target substance from a sample solution containing a target substance or a target substance-containing substance, and a method for producing a concentrated solution using the pipette tip, the pipette tip includes a tip main body that stores a liquid; and a filter disposed in a lower opening portion of a lower end of the tip main body, an inclined portion is provided in at least a part of the lower opening portion in which the filter of the lower end of the tip main body is disposed, and the carrier is held in the tip main body.

### CROSS-REFERENCE TO RELATED APPLICATIONS

This application claims priority to Japanese Patent Application Nos. 2024-036061 filed Mar. 8, 2024 and 2024-232677 filed Dec. 27, 2024, the disclosures of which are hereby incorporated by reference in their entireties.

### BACKGROUND

### Field of the Invention

The present invention relates to a pipette tip and a method for producing a concentrated solution using the same.

### Description of Related Art

Chromatography for separating and purifying a target substance from a sample solution containing a plurality of substances can be classified into two types: continuous chromatography using a packed column (hereinafter referred to as column chromatography) and batch chromatography.

Batch chromatography is a method in which a carrier and a sample solution are mixed in a container, and then the carrier capturing a target substance and the sample solution are separated. Examples of means for separating the carrier from the sample solution include a method for centrifuging a mixture of the sample solution and the carrier and separating the carrier as a precipitate, a method for placing the mixture of the sample solution and the carrier on a filter cartridge and then centrifuging the mixture to separate the carrier as a residue on the filter, and a method for separating the carrier by a magnet, using magnetic beads as a carrier.

In general, batch chromatography has an advantage of being able to perform separation quickly as separation can be performed at once even when a large amount of sample solution is used. In addition, since the carrier is likely to be dispersed in the sample solution, the target substance is likely to be captured by the carrier. On the other hand, since the total amount of the sample solution comes into contact with the carrier at once, the sample solution is excessively present with respect to the carrier, and when the binding properties between the target substance and the carrier are not so strong, the target substance may not be sufficiently captured. In addition, the centrifugation operation or use of magnetic beads is essential, but during the centrifugation operation, there is a risk of the sample solution leaking or scattering due to breakage of a tube or looseness of a lid in the middle of the centrifugation operation, leading to the spread of contamination, and there is a problem that it is difficult to recover the magnetic beads in a case where, for example, the concentration of a target substance in the sample solution is low.

Column chromatography is a method in which a sample solution is brought into contact with a carrier packed in a column online, and a target substance is captured by the carrier and then released. In column chromatography, since the sample solution passes through the column packed with the carrier from the top to the bottom, there is an advantage that the target substance is likely to be captured by the carrier during that time. Examples of methods using column chromatography to separate and purify a target substance from multiple sample solutions containing such as proteins, nucleic acids, lipids, saccharides, viruses, and exosomes using column chromatography include a method using a spin column or a column tip that use a carrier having characteristics corresponding to a target substance.

In the column tip, a carrier having characteristics corresponding to a target substance is enclosed in a pipette tip having a special shape, and is used by being attached to the tip end of the pipette. Since a target substance can be separated and purified only by a suction/discharge operation of a pipette, the operation is simple and likely to be adaptable to an automated robot liquid handler, and thus, the target substance is widely used in situations where simultaneous processing of multiple specimens is required. An example of a commercially available column tip is PhyTip (registered trademark) from Biotage.

Since the column tip usually has a structure in which filters are disposed above and below the carrier and the carrier is sandwiched between the filters, the carrier is less likely to disperse in the liquid sucked into the column tip. Therefore, the target substance in the liquid and the carrier are less likely to encounter each other, and only a part of the target substance is often adsorbed to the carrier. In addition, when air bubbles enter the column tip at the time of suction and discharge, the adsorption efficiency is likely to deteriorate. Further, the column tip has a narrow width and is likely to be clogged, and there is a case where suction and discharge cannot be repeated unless the suction and discharge speed is significantly reduced, and there is a possibility that a pressure is applied to the filter and the filter is damaged. For these reasons, the target substance may not be sufficiently purified.

As a column tip capable of enhancing the uniformity of encounter between a target substance in a liquid and a carrier and efficiently reacting or binding the target substance and the carrier, a diffusible carrier-encapsulated flow tube (tip) having a turbulent flow generating member capable of generating a turbulent flow that diffuses the carrier has been reported (Patent Literature 1: Japanese Patent No. 5732407). However, since this tip has a complicated structure and has a small-diameter tube (for example, FIG. 3 of Japanese Patent No. 5732407) at the end of the tip, a certain amount of liquid remains in the tip after discharge, and the dead volume is not small. When the dead volume is large, particularly when the amount of liquid at the time of elution is greatly reduced as compared with the sample solution to concentrate the target substance, there is a problem that a certain amount of the concentrated solution remains in the tip and the recovery rate of the concentrated solution decreases.

### SUMMARY

There is provided a pipette tip capable of repeatedly dispersing a carrier in the tip by suction and discharge, and producing a concentrated solution having a small dead volume and having increased concentration of a target substance from a sample solution containing the target substance or a target substance-containing substance, and a method for producing a concentrated solution using the pipette tip.

The present inventors have intensively studied to solve the above problems. As a result, the present inventors have found that the above problem can be solved by having the following configuration, and have completed the present invention.

The present invention relates to, for example, the following [1] to [7]. [1] A pipette tip including:
a tip main body that stores liquid; and
a filter disposed in a lower opening portion of a lower end of the tip main body, wherein
an inclined portion is provided in at least a part of the lower opening portion in which the filter of the lower end of the tip main body is disposed, and
a carrier is held in the tip main body. [2] The pipette tip according to [1], in which an inclination angle of the inclined portion is greater than 20° and 70° or less with respect to a line orthogonal to an axis of the pipette tip in a front view of the pipette tip. [3] The pipette tip according to [1] or [2], in which the carrier is hydroxyapatite or a magnetic carrier. [4] The pipette tip according to any one of [1] to [3], in which a material constituting the filter is polytetrafluoroethylene (PTFE) or polyvinylidene fluoride (PVDF).
[5] The pipette tip according to any one of [1] to [4], in which a melting point of a material constituting the filter is higher than a melting point of a material constituting the tip main body, and the filter is fused to the lower opening portion. [6] The pipette tip according to any one of [1] to [5] for producing a concentrated solution having increased concentration of a substance α from a sample solution containing a target substance (substance α) or a substance α-containing substance (substance β). [7] A method for producing a concentrated solution having increased concentration of a substance α from a sample solution containing a target substance (substance α) or a substance α-containing substance (substance β) using the pipette tip according to any one of [1] to [6], the method including:
a step A of sucking and discharging the sample solution through a lower opening portion of a lower end of the pipette tip to adsorb the substance α or the substance β to the carrier; and
a step B of sucking and discharging a releasing solution to release the substance α from the carrier, thereby obtaining a concentrated solution having increased concentration of the substance α.

In the pipette tip according to one aspect of the present invention, it is possible to repeatedly disperse the carrier in the tip by suction and discharge, and the pipette tip has a small dead volume, and it is possible to produce a concentrated solution having increased concentration of the target substance from a sample solution containing the target substance or the target substance-containing substance. In addition, according to the method for producing a concentrated solution, which is an aspect of the present invention, a concentrated solution having increased concentration of a target substance can be produced from a sample solution containing a target substance or a target substance-containing substance.

### BRIEF DESCRIPTION OF THE DRAWINGS

FIG. 1 is an example of a shape near a lower end of a pipette tip of the present invention. Dotted lines indicate filters;

FIG. 2 is a six-sided view of the pipette tip according to the first embodiment;

FIG. 3 is a perspective view of a pipette tip according to the first embodiment illustrated in FIG. 2;

FIG. 4 is a six-sided view of a pipette tip according to a second embodiment;

FIG. 5 is a perspective view of the pipette tip according to the second embodiment illustrated in FIG. 4;

FIG. 6 is a six-sided view of a pipette tip according to a third embodiment;

FIG. 7 is a perspective view of the pipette tip according to the third embodiment illustrated in FIG. 6;

FIG. 8 is a six-sided view of a pipette tip according to a fourth embodiment;

FIG. 9 is a perspective view of the pipette tip according to the fourth embodiment illustrated in FIG. 8;

FIG. 10 is a photograph of a state where a solution is sucked and discharged with a pipette tip of Examples 2, 3, 4, and 5;

FIG. 11 is an enlarged photograph, compared to FIG. 10, illustrating a state where a solution is sucked and discharged with the pipette tip of Examples 2, 3, 4, and 5;

FIG. 12 is a conceptual diagram of a dispersion state of carriers in the pipette tip;

FIG. 13 is a photograph of a state where a solution is sucked and discharged with a pipette tip of Examples 1, 4, and 6;

FIG. 14 is a photograph of a state where a solution is sucked and discharged with a pipette tip of Example 7;

FIG. 15 is a diagram illustrating results of detecting CD9 by Western blot in Experimental Example 7;

FIG. 16 is a diagram illustrating results of detecting CD9 by Western blot in Experimental Example 8;

FIG. 17 is a diagram illustrating results of detecting CD9 by Western blot in Experimental Example 9;

FIG. 18 is an amplification curve in quantitative PCR in Experimental Example 10;

FIG. 19 illustrates results of silver staining of SDS-PAGE gels in Experimental Example 11;

FIG. 20 is a diagram illustrating results of CBB staining of SDS-PAGE gels in Experimental Example 12; and

FIG. 21 is a diagram illustrating results of CBB staining of SDS-PAGE gels in Experimental Example 13.

### DESCRIPTION OF THE INVENTION

Next, the present invention will be specifically described.

The expression “A to B” in the numerical range means A or more and B or less unless otherwise specified. In addition, % means mass %.

### [Pipette Tip]

A pipette tip according to an aspect of the present invention includes: a tip main body that stores liquid; and a filter disposed in a lower opening portion of a lower end of the tip main body, in which an inclined portion is provided in at least a part of the lower opening portion in which the filter is disposed, and a carrier is held in the tip main body.

The pipette tip can be used for producing a purified solution having increased purity of the substance α from a sample solution containing a target substance (hereinafter also referred to as “substance α”) or a target substance-containing substance (hereinafter also referred to as “substance β”), or for producing a concentrated solution having increased concentration of the substance α from a sample solution containing the substance α or the substance β, but is preferably used for producing a concentrated solution having increased concentration of the substance α from a sample solution containing the substance α or the substance β.

The pipette tip is used together with a pipetting device such as a pipette for sucking and discharging a liquid.

The pipetting device is not particularly limited as long as the pipetting device is a device that performs an operation of sucking and discharging a liquid, and examples thereof include pipettes such as micropipettes, macropipettes, volumetric pipettes, and Komagome pipettes, and a robot liquid handler in which an operation of detaching a pipette tip is automated in addition to the suction/discharge operation. From the viewpoint of safety and contamination prevention, micropipettes, macropipettes, and robot liquid handlers are preferable.

The robot liquid handler may be an automatic nucleic acid purification device or an automatic protein purification device, and examples of such an automatic purification device include the magLEAD system (manufactured by Precision System Science Co., Ltd.), the Purelumn system (manufactured by Precision System Science Co., Ltd.), the Assist Plus (manufactured by Integra Biosciences Ltd.), and the CyBio Felix (manufactured by Analytik Jena GmbH+Co. KG).

The pipetting device may be manual or electric, but an electric pipetting device is preferable because the pipetting operation can be accurately performed. The pipetting device may include a plurality of channels.

From the viewpoint of safety and contamination prevention, the pipette tip is preferably a disposable pipette tip.

The pipette tip main body has an elongated tubular body, has a lower opening portion for passing a liquid through a lower end of the pipette tip main body, and has an upper opening portion at an upper end for fitting to an attachment of a pipetting device.

The specification of the pipette tip main body follows ISO 8655-1:2022 as necessary.

The attachment of a pipetting device is typically a conical or frustoconical attachment that is standardized in many manufacturers and is known to have a standard shape characterized by a specific average diameter and a specific cone angle of the conical attachment for each pipette tip size. The shape and size of the upper opening portion of the pipette tip main body are not particularly limited as long as the upper opening portion can be fitted to such an attachment.

The shape of the tip main body is not particularly limited, but preferably has a taper from the top to bottom, and the cross section thereof increases from the lower opening portion toward the upper opening portion.

The tip main body stores liquid therein.

The volume of the tip main body is not particularly limited, but is preferably a volume capable of handling liquid, such as 0.1 μL to 10 μL, 0.5 μL to 10 μL, 2 to 200 μL, 30 to 300 μL, 100 to 1,000 μL, 500 to 5,000 μL, or 1,000 to 10,000 μL.

The material of the tip main body is not particularly limited, and a known material can be used.

The material of the tip main body preferably has non-adsorbability for the substance α or the substance β and does not have reactivity to the sample solution. Here, the term “adsorbability” means a property of adsorbing under a specific adsorption condition, and the term “non-adsorbability” means non-adsorbability under a specific condition.

It is preferable that the material of the tip main body can withstand such as electron beam sterilization treatment for sterilization treatment, gamma ray sterilization treatment, or autoclave treatment.

The material of the tip main body is preferably a synthetic resin.

Examples of the synthetic resin include polystyrene, polycarbonate, polyethylene, polypropylene, polyethylene terephthalate, polyetherimide, polyimide, ABS resin, polyvinyl chloride, polyvinylidene chloride, and fluororesin. These may be used alone, or in combination of two or more types thereof. The synthetic resin is preferably polypropylene because polypropylene has high transparency and is less likely to adsorb drugs. The tip main body is preferably an integrally molded structure formed of a synthetic resin.

The surface of the synthetic resin may be subjected to a low drug adsorption treatment with a hydrophilic compound.

Examples of hydrophilic compounds include phosphorylcholine group-containing compounds such as poly((meth)acryloyloxyethyl phosphorylcholine) which is a homopolymer of 2-methacryloyloxyethyl phosphorylcholine, and copolymers of (meth)acryloyloxyethyl phosphorylcholine and (meth)acrylic monomers.

The shape and size of the lower end of the tip main body are not particularly limited as long as the lower end has a lower opening portion.

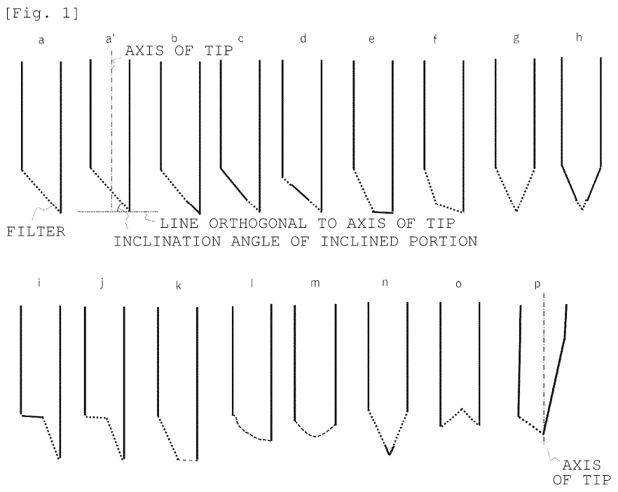

FIG. 1 illustrates an example of a shape near a lower end of the pipette tip. The pipette tip may have, for example, shapes of a top of FIG. 1 in a front view of the pipette tip. In FIG. 1, for the sake of simplicity, the carrier is not described.

The entire lower end of the tip main body may be a lower opening portion (for example, a, f, g, j, k, l, m, o, and p of FIG. 1) or a part thereof may be a lower opening portion (for example, b, c, d, e, h, i, and n of FIG. 1), but the entire lower end of the tip main body is preferably a lower opening portion because of excellent liquid permeability and good dispersibility of the carrier.

A filter is disposed in a lower opening portion of the end of the tip main body.

The lower opening portion is usually entirely covered with a filter in order to hold the carrier in the tip main body.

The shape and size of the lower opening portion are not particularly limited, but are preferably circular, elliptical, substantially circular, or substantially elliptical.

The position of the lower opening portion is not particularly limited as long as the liquid can pass therethrough as a pipette tip, but may be a position including the lowermost end of the pipette tip (for example, a, c to k, l, m, o, and p of FIG. 1) or a position not including the lowermost end (for example, b and n of FIG. 1). However, since the dead volume is small and the carrier is less likely to remain near the lowermost end of the pipette tip even when suction and discharge are repeated, a position including the lowermost end of the pipette tip is preferable.

The shape of the lowermost end of the pipette tip is not particularly limited, and may be an acute angle (for example, a to d, f to j, n, o, and p of FIG. 1) or an obtuse angle (for example, e and k of FIG. 1) in a front view of the pipette tip, but is preferably an acute angle.

At least one lower opening portion may be provided, and two or more lower opening portions may be provided (for example, d and n of FIG. 1).

An inclined portion is provided in at least a part of the lower opening portion in which the filter is disposed.

The lower opening portion in which the filter is disposed is entirely or partially provided with an inclined portion, and preferably, the entire lower opening portion in which the filter is disposed is provided with an inclined portion (for example, a to i, k, and p of FIG. 1).

When an inclined portion is provided in the lower opening portion in which the filter is disposed (for example, j of FIG. 1), a part other than the inclined portion of the lower opening portion is usually orthogonal to an axis of the pipette tip in a front view of the pipette tip.

At least one inclined portion may be provided, and a plurality of inclined portions may be provided. When a plurality of the inclined portions are provided, the inclination angles of the plurality of inclined portions may be the same (for example, g, h, n, and o of FIG. 1) or different (for example, f of FIG. 1).

When a plurality of the inclined portions is provided, the plurality of inclined portions may be provided to protrude toward the outer side of the tip main body (for example, f, g, h, and n of FIG. 1), or may be provided to protrude toward the inner side of the tip main body (for example, o of FIG. 1), but is preferably provided to protrude toward the outer side of the tip main body.

By providing the inclined portion on the pipette tip, the sample solution is smoothly sucked and discharged, and the carrier in the pipette tip is efficiently dispersed in the sample solution by suction and discharge. In addition, the carrier can be repeatedly dispersed by suction and discharge.

When the pipette tip is provided with the inclined portion, a carrier is dispersed in a sample solution in the pipette tip at the time of suction, and a state similar to batch chromatography is obtained. Therefore, it is easy to obtain the same advantages as in batch chromatography that the carrier is likely to be dispersed in the sample solution and the substance α or the substance β is likely to be adsorbed to the carrier. In particular, when a turbulent flow is generated along with suction, this advantage is likely to be achieved. The carriers accumulated on the filter after discharge may be less likely to disperse even when the carriers are sucked as they are. However, when a turbulent flow occurs along with suction, the carriers are likely to sufficiently disperse at the time of suction even in a state where the carriers are aggregated immediately after discharge.

When the pipette tip is provided with the inclined portion, the carrier is accumulated on the filter at the time of discharge, and the sample solution is delivered from the top to the bottom of the accumulated carrier, and thus a state similar to that of column chromatography is obtained. Therefore, it is easy to obtain the same advantage as the column chromatography that the substance α or the substance β in the sample solution is likely to be adsorbed to the carrier. In particular, in a case where the position of the carrier on the filter changes toward the lowermost end of the pipette tip due to gravity and the carrier covers only a part of the filter surface during the period from the discharge to the next suction, this advantage is likely to be achieved.

When the pipette tip is provided with the inclined portion, when suction and discharge of the sample solution are repeated, a state similar to that in a case where batch chromatography and column chromatography are repeatedly performed is obtained. Therefore, advantages of both batch chromatography and column chromatography are likely to be obtained.

The inclined portion may be a flat surface (for example, a to k, n, o, and p of FIG. 1) or a curved surface (for example, 1 and m of FIG. 1), but is preferably a flat surface.

When the inclined portion is a flat surface, an inclination angle of the inclined portion is not particularly limited as long as the inclination angle is larger than 0° with respect to a line orthogonal to an axis of the pipette tip in a front view of the pipette tip. The front view refers to a state where the pipette tip is used together with a pipetting device and viewed from a direction that best illustrates the characteristics of the shape of the pipette tip.

The inclination angle of the inclined portion is an angle formed by a line orthogonal to the axis of the pipette tip and the inclined portion, which is larger than 0° and smaller than 90°. The axis of the pipette tip refers to a line passing through the centroid in the axial direction of the pipette tip (longitudinal direction of the pipette tip). a′ of FIG. 1 is a diagram illustrating these concepts with reference to a of FIG. 1.

An inclination angle of the inclined portion is preferably larger than 20° and 70° or less, and more preferably 40° or more and 70° or less with respect to a line orthogonal to an axis of the pipette tip in a front view of the pipette tip.

When the inclination angle of the inclined portion is within the range, the carrier in the tip main body can be more efficiently dispersed.

When the inclination angle of the inclined portion is larger than 40° and smaller than 70° with respect to a line orthogonal to an axis of the pipette tip in a front view of the pipette tip, a turbulent flow is likely to occur along with the suction of the solution. In addition, as the solution is discharged, the carrier is likely to accumulate on the filter to uniformly cover the entire surface of the filter. After discharge, before the next suction, the position of the carrier on the filter changes toward the lowermost end of the pipette tip due to gravity, and the carrier is likely to be in a state of covering only a part of the filter surface. In addition, even when the solution is repeatedly sucked and discharged, the carrier is less likely to remain near the lowermost end of the pipette tip. Furthermore, the shape near the lowermost end of the pipette tip is likely to be stabilized and likely to manufacture.

When the inclined portion is a curved surface, the inclined portion is preferably formed in an arc shape (for example, 1 and m of FIG. 1) in front view of the pipette tip, and may be an arc shape protruding toward the outer side of the tip main body, an arc shape protruding toward the inner side of the tip main body, or an arc shape combining a protrusion toward the outer side of the tip main body and a protrusion toward the inner side of the tip main body.

The position of the lowermost end of the tip main body is not particularly limited, but when the lowermost end of the tip main body is formed (for example, g, h, m, and p of FIG. 1) on the axis of the tip main body, it is likely to efficiently suck and discharge the solution of which the lower end is in the U-shaped tube.

The surface area of the inclined portion is not particularly limited, and may be appropriately determined according to the capacity of the pipette tip main body or the amount of the carrier. For example, when the capacity of the pipette tip main body is a capacity capable of handling a liquid of 1,000 μL to 10,000 μL and the volume of the concentrated solution is 50 to 300 μL, the surface area of the inclined portion is preferably 0.05 to 9 cm² and more preferably 0.1 to 2.0 cm².

In the pipette tip, since the inclined portion is provided in at least a part of the lower opening portion in which the filter is disposed at the lower end of the tip main body, the carrier in the pipette tip is likely to be dispersed by suction and discharge, and the structure is simple, and thus the dead volume is small.

The pipette tip holds a carrier in the tip main body.

The pipette tip may have a barrier filter above the carrier in the pipette tip main body in order to prevent contamination or prevent the carrier from coming out of the upper opening portion when the pipette tip is tilted.

The position of the barrier filter is not particularly limited as long as the position is above the carrier, but is preferably near the upper opening portion of the pipette tip main body not to come into contact with the sucked liquid.

The material of the barrier filter is not particularly limited as long as the material allows permeation of gas and does not allow the carrier to pass through, and a known material can be used.

The material of the barrier filter preferably prevents the passage of aerosol, more preferably polyethylene, and even more preferably sintered high density polyethylene granules.

The method for producing the pipette tip is not particularly limited, and the pipette tip can be produced by a known method. The lower opening portion may be obtained, for example, by injection-molding a pipette tip having a shape having a lower opening portion, or the lower opening portion may be provided by secondary processing of a lower end of a main body of an existing tip.

### [Filter]

The filter is disposed in a lower opening portion of a lower end of the tip main body to hold the carrier in the tip main body. The filter is a filter that does not allow the carrier to pass through, specifically, a filter having pores with a size that does not allow the carrier to pass through.

The filter has a pore having a size through which the substance α in the sample solution can pass, specifically, the substance α can pass.

The filter is preferably a filter which does not allow the carrier to pass through and through which the substance α and the substance β in the sample solution can pass. Specifically, the filter is preferably a filter which does not allow the carrier to pass through and has a pore having a size through which the substance α and the substance β can pass.

The pore size of the filter is not particularly limited as long as the pore size does not allow the carrier to pass through, that is, the pore size is smaller than the size of the carrier.

The pore size of the filter is not particularly limited as long as the substance α can pass therethrough, that is, the pore size is larger than the size of the substance α.

The pore size of the filter preferably does not allow the carrier to pass through but allows the substance α and the substance β to pass through, that is, the pore size is smaller than the size of the carrier and preferably larger than the sizes of the substance α and the substance β.

The pore size of the filter can be appropriately selected in a range of about 100 nm or more and less than 2 mm according to the size of the carrier and the substance α or the substance β to be used, and is preferably 100 nm to 20 μm, more preferably 500 nm to 10 μm, and still more preferably 500 nm to 5 μm.

In general batch chromatography, it is considered that the amount ratio of the carrier to the sample solution is always constant while the sample solution and the carrier are in contact with each other as one of factors that the target substance cannot be sufficiently captured. On the other hand, the pipette tip of the embodiment of the present invention is a device that performs a type of batch chromatography, but since the carrier cannot pass through the filter, the pipette tip remains in the tip main body, but the sample solution can pass through the filter and move back and forth between the inside of the tip main body and the outside of the tip. Therefore, the amount ratio of the carrier and the sample solution changes while the sample solution and the carrier are in contact with each other. Therefore, the substance α or the substance β can be sufficiently adsorbed to the carrier.

For example, when a sample solution containing viruses or exosomes is used, in general, the diameter of the viruses is about 100 to 200 nm, the diameter of the exosomes is about 20 to 200 nm, and the average particle size of the carrier is preferably 0.5 μm to 2 mm. Therefore, the pore size of the filter can be appropriately selected in the range of about 200 nm to 2 mm corresponding to these diameters, but is preferably 250 nm to 20 μm, more preferably 500 nm to 10 μm, and still more preferably 500 nm to 5 μm.

In addition, for example, when a sample solution containing a protein is used, in general, the diameter of the protein is about 1 to 100 nm, and the average particle size of the carrier is preferably 0.5 μm to 2 mm. Therefore, the pore size of the filter can be appropriately selected in the range of about 100 nm to 2 mm, corresponding to these diameters, but is preferably 250 nm to 20 μm, more preferably 500 nm to 10 μm, and still more preferably 500 nm to 5 μm.

The aspect of the filter is not particularly limited, and examples thereof include a porous membrane having a continuous pore structure, or a woven fabric or a nonwoven fabric composed of fibers or ultrafine fibers, but a porous membrane or a nonwoven fabric is preferable, and a nonwoven fabric is more preferable. The ultrafine fiber is a fiber having a diameter of 5 μm or less, and preferably a fiber having a diameter of about 1 μm.

The material constituting the filter is not particularly limited, but a material that is less likely to adsorb the substance α and the substance β is preferable.

The filter is preferably a filter having hydrophilicity from the viewpoint that, for example, the substance α and the substance β are less likely to be adsorbed. Examples of the filter having hydrophilicity include a filter made of a hydrophilic material and a filter obtained by hydrophilizing a filter made of a material having insufficient hydrophilicity.

When a hydrophilic filter is used as the filter, even when the amount of the sample solution is small and a part of the filter is not immersed in the sample solution, bubbles are less likely to enter the liquid in the pipette tip, and a problem is less likely to occur in the subsequent suction and discharge. Without being bound by theory, it is considered that this is because the filter has hydrophilicity, and thus even when only a part of the filter comes into contact with the sample solution, the entire filter is likely to be wetted, and the filter is less likely to permeate air.

Examples of the material of the filter include thermoplastic resins such as polyolefin (for example, polyethylene and polypropylene), polystyrene, ABS resin, AS resin, EVA resin, polymethylpentene, polyvinyl chloride, polyvinylidene chloride, poly(meth)acrylic acid ester, polyvinyl acetate, polyamide, polyimide, polycarbonate, polyethylene terephthalate, polybutylene terephthalate, polyacetal, polyarylate, polysulfone, and fluororesin; biodegradable resins such as polylactic acid, polyhydroxybutyrate, modified starch resin, polycaprolactone, polybutylene succinate, polybutylene adipate terephthalate, polybutylene succinate terephthalate, and polyethylene succinate; thermosetting resins such as phenol resin, urea resin, melamine resin, unsaturated polyester resin, diallyl phthalate resin, epoxy resin, epoxy (meth)acrylate resin, silicon resin, (meth)acrylic urethane resin, and urethane resin; elastomers such as silicone resin, polystyrene elastomer, polyethylene elastomers, polypropylene elastomers, polyurethane elastomer, and fluoroelastomers (for example, FKM and FFKM); natural materials such as pulp, hemp, cellulose, kenaf, chitin, chitosan, and cotton; and inorganic materials such as glass, silica, and metal. These materials may be used alone or in combination of two or more types thereof.

From the viewpoint of heat resistance and processability, the material constituting the filter preferably contains a fluororesin or a fluoroelastomer, more preferably a fluororesin or a fluoroelastomer, and still more preferably a filter composed of a hydrophilized fluororesin or a hydrophilized fluoroelastomer (particularly, hydrophilized FKM).

The fluororesin is not particularly limited, and examples thereof include polytetrafluoroethylene (PTFE), tetrafluoroethylene-perfluoroalkyl vinyl ether copolymer (PFA), tetrafluoroethylene-hexafluoropropylene copolymer (FEP), ethylene-tetrafluoroethylene copolymer (ETFE), tetrafluoroethylene-hexafluoropropylene-perfluoroalkyl vinyl ether copolymer (EPE), fluoroethylene-vinyl ether copolymer (FEVE), poly(chlorotrifluoroethylene) (PCTFE), ethylene-chlorotrifluoroethylene-copolymer (ECTFE), polyvinylidene fluoride (PVDF), polyvinyl fluoride (PVF), vinylidene fluoride-hexafluoropropylene copolymer (VDF-HFP copolymer), and vinylidene fluoride-hexafluoropropylene-tetrafluoroethylene copolymer (VDF-HFP-TFE copolymer). Among these, PTFE and PVDF are preferable, and PTFE is more preferable from the viewpoint of further exhibiting the effects of the present invention and further, for example, excellent chemical resistance.

As a material constituting the filter, among these materials, because of the good liquid permeability, a woven fabric or a nonwoven fabric composed of PTFE-containing fibers or ultrafine fibers is preferable, a woven fabric or a nonwoven fabric composed of PTFE fibers or ultrafine fibers is more preferable, and a nonwoven fabric composed of hydrophilized PTFE ultrafine fibers is still more preferable.

The fluoroelastomer is not particularly limited, but examples thereof include perfluoro (alkyl vinyl ether), perfluoro (alkoxyalkyl vinyl ether), vinylidene fluoride-hexafluoropropylene-based polymer, vinylidene fluoride-hexafluoropropylene-tetrafluoroethylene-based polymer, tetrafluoroethylene-propylene-based polymer, vinylidene fluoride-propylene-tetrafluoroethylene-based polymer, ethylene-tetrafluoroethylene-perfluoromethyl vinyl ether-based polymer, vinylidene fluoride-tetrafluoroethylene-perfluoromethyl vinyl ether-based polymer, and vinylidene fluoride-perfluoromethyl vinyl ether-based polymer. Among these, from the viewpoint of, for example, excellent heat resistance or chemical resistance, a ternary FKM is preferable, and vinylidene fluoride-hexafluoropropylene-tetrafluoroethylene-based polymer is more preferable.

The hydrophilization treatment preferably includes a step of coating a filter with a compound having a hydrophilic group (hereinafter also referred to as “hydrophilic compound”), and more preferably includes a step of immersing the filter in a solution of a hydrophilic compound, coating the filter with a hydrophilic compound, and then crosslinking the hydrophilic compound. Specific examples of such a step include steps described in WO 2014/021167 and JP 4-075051 B.

The hydrophilization treatment may be repeated a plurality of times. The filter may be immersed in a solution of a hydrophilic compound, coated with the hydrophilic compound, then crosslinked with the hydrophilic compound, and then further the filter may be immersed in a solution of a hydrophilic compound that is the same as or different from the hydrophilic compound which was already used, and the filter may be coated with the hydrophilic compound.

The hydrophilic compound is not particularly limited as long as the effect of the present invention is not impaired, and a compound having any shape such as a linear shape, a branched shape, or a dendrimer shape can be used.

Examples of the hydrophilic compound include a hydroxyl group-containing compound, a carboxylic acid group-containing compound, a sulfonic acid group-containing compound, an ether group-containing compound, an epoxy group-containing compound, an amino group-containing compound, an amide group-containing compound, and a phosphorylcholine group-containing compound.

The hydrophilic compound may be used alone or in combination of two or more types thereof.

The hydroxyl group-containing compound is not particularly limited, and examples thereof include polyvinyl alcohol (PVA) and modified products thereof (for example, ethylene oxide group-modified PVA, carboxyl group-modified PVA, sulfonic acid group-modified PVA, and quaternary ammonium-modified PVA); polysaccharides such as agarose, dextran, chitosan, cellulose, and heparin, and derivatives thereof; collagen; gelatin; copolymer of vinyl alcohol and vinyl group-containing monomer (for example, vinyl alcohol-vinyl acetate copolymer, ethylene-vinyl alcohol copolymer, and vinyl alcohol-polyvinyl pyrrolidone copolymer); polyols such as (meth)acrylic polyol, fluorine-containing polyol, polyoxyalkylene (for example, polyethylene glycol, and copolymer of polyethylene glycol and polypropylene glycol [for example, Pluronic F108 and Pluronic F127 (both manufactured by Sigma-Aldrich Co. LLC)]), polyester polyol, and diethylene glycol; and hydroxyl group-containing (meth)acrylic compounds such as poly(2-hydroxyethyl (meth)acrylate), 1-hydroxypropane-2-yl=(meth)acrylate, 2-hydroxypropane-1-yl=(meth)acrylate (another name: 2-hydroxypropyl (meth)acrylate), 2-hydroxy-1-methylethyl (meth)acrylate, hydroxypropyl (meth)acrylate, 2,3-dihydroxypropyl (meth)acrylate, and hydroxyethyl (meth)acrylate.

The carboxylic acid group-containing compound is not particularly limited, and examples thereof include a copolymer of any one or two or more monomers among olefinic monomers such as ethylene, propylene, and butylene, diene-based monomers such as butadiene, aromatic group-containing monomers such as styrene, and (meth)acrylic acid ester-based monomers, and a monomer having a carboxylic acid group [—COOH] such as (meth)acrylic acid; homopolymer of monomer having carboxylic acid group such as (meth)acrylic acid; and amino acid.

The sulfonic acid group-containing compound is not particularly limited, and examples thereof include a copolymer of styrene and acrylamide-2-methylpropane sulfonic acid (salt); ternary copolymer of styrene, n-butyl acrylate, and acrylamide-2-methylpropane sulfonic acid (salt); and ternary copolymer of styrene, 2-ethylhexyl acrylate, and acrylamide-2-methylpropane sulfonic acid (salt).

The ether group-containing compound is not particularly limited, and examples thereof include polyethylene glycol and derivatives thereof, fluororesins having an ether group, polyurethane resins having an ether group, and polyphenylene resins having an ether group.

The epoxy group-containing compound is not particularly limited, and examples thereof include epoxy resins, modified epoxy resins, (meth)acrylic (co)polymers having an epoxy group, polybutadiene resins having an epoxy group, polyurethane resins having an epoxy group, and adducts or condensates of these resins.

The amino group-containing compound is not particularly limited, and examples thereof include polyethyleneimine, polyvinylamine, polyamidopolyamine, polyamidine, polydimethylaminoethyl methacrylate, and polydimethylaminoethyl acrylate.

The amide group-containing compound is not particularly limited, and examples thereof include poly(N-isopropyl (meth)acrylamide) and poly(N-vinyl-2-pyrrolidone).

The phosphorylcholine group-containing compound is not particularly limited, and examples thereof include poly((meth)acryloyloxyethyl phosphorylcholine) which is a homopolymer of 2-methacryloyloxyethyl phosphorylcholine, and a copolymer of (meth)acryloyloxyethyl phosphorylcholine and a (meth)acrylic monomer.

The weight average molecular weight of the hydrophilic compound is not particularly limited, but is preferably 100 to 1,000,000.

The time for immersing the filter in the solution of the hydrophilic compound is not particularly limited as long as the filter can be coated with the hydrophilic compound, and is preferably 1 second to 60 minutes, and more preferably 10 seconds to 30 minutes although depending on, for example, the concentration of the hydrophilic compound in the solution of the hydrophilic compound to be used.

The immersion temperature and atmosphere are not particularly limited, and may be appropriately selected according to, for example, the type of the hydrophilic compound.

In addition, when an aqueous solution is used as the solution of the hydrophilic compound, even when the filter that has not been subjected to any treatment is immersed in the aqueous solution of the hydrophilic compound, the hydrophilic compound may not penetrate into the filter. Therefore, before immersing the filter in the solution of the hydrophilic compound, for example, it is preferable to immerse the filter in a solvent compatible with water such as isopropyl alcohol (impregnate the filter with a solvent compatible with water).

When the filter is immersed in a solvent compatible with water, preferably, the filter immersed in the solvent compatible with water is taken out from the solvent, and then the filter is immersed in a solution of a hydrophilic compound to replace the solvent compatible with water and the hydrophilic compound. In this case, the hydrophilic compound may be pushed into the filter by applying mechanical strength to the filter. Specifically, the filter may be likely to be impregnated with the hydrophilic compound by pressing and rubbing, or by pressure reduction or pressurization using a vacuum pressurization impregnation apparatus.

The solvent compatible with water is not particularly limited, but a solvent that is likely to penetrate into the filter and likely to volatilize is preferable, and specific examples thereof include alcohols such as methyl alcohol, ethyl alcohol, n-propyl alcohol, isopropyl alcohol, n-butyl alcohol, sec-butyl alcohol, tert-butyl alcohol, and isobutyl alcohol; esters such as methyl acetate, ethyl acetate, and butyl acetate; ketones such as acetone and methyl ethyl ketone; ethers such as tetrahydrofuran and dioxane; and aprotic polar solvents such as dimethyl sulfoxide and N, N-dimethylformamide. Among these, methyl alcohol, ethyl alcohol, or isopropyl alcohol is preferable from the viewpoint of, for example, ease of penetration into the filter.

In addition, the solvent compatible with water may be a liquid obtained by mixing water with at least one selected from the alcohols, esters, ketones, ethers, and aprotic polar solvents.

These solvents compatible with water may be used alone or in combination of two or more types thereof.

The time for immersing the filter in a solvent compatible with water is not particularly limited, and is, for example, 1 minute to 24 hours.

The immersion temperature and atmosphere are not particularly limited.

Examples of the method for crosslinking the hydrophilic compound include irradiation crosslinking by an ionizing radiation such as an electron beam, thermal crosslinking, and chemical crosslinking using a crosslinking agent. Among these crosslinking methods, chemical crosslinking using a crosslinking agent is preferable because crosslinking can be performed even in an aqueous solution, and from the viewpoint of, for example, reliability of crosslinking.

The crosslinking agent to be used in the chemical crosslinking is not particularly limited, and may be appropriately selected according to the type of hydrophilic compound to be used, and examples thereof include aldehyde-based compounds such as formaldehyde, glutaraldehyde, and terephthalaldehyde; ketone compounds such as diacetyl and chloropentanedione; a compound having a reactive halogen such as bis(2-chloroethylurea)-2 hydroxy-4,6-dichloro-1,3,5-triazine; a compound having reactive olefin such as divinylsulfone; N-methylol compound; isocyanates; aziridine compounds; carbodiimide-based compound; epoxy compound; halogen carboxyaldehydes such as mucochloric acid; dioxane derivatives such as dihydroxydioxane; inorganic crosslinking agents such as chromium alum, zirconium sulfate, boric acid, borate, and phosphate; diazo compound such as 1,1-bis(diazoacetyl)-2-phenylethane; a compound containing disuccinimidyl ester; and difunctional maleimides.

These crosslinking agents may be used alone or in combination of two or more types thereof.

The crosslinking agent is preferably used in an amount that is greatly excessive with respect to the amount of the hydrophilic compound in the solution of the hydrophilic compound used.

From the viewpoint of, for example, easily obtaining a filter excellent in chemical resistance, the temperature at the time of crosslinking is preferably 10 to 95° C., and more preferably 20 to 60° C.

The crosslinking time at the time of crosslinking is preferably 1 to 60 minutes from the viewpoint of, for example, durability and productivity of the obtained filter.

The hydrophilized filter is preferably cleaned with, for example, water for the purpose of, for example, removing unreacted hydrophilic compounds. This step may be performed under heating as necessary.

The melting point of the material constituting the filter is preferably higher than the melting point of the material constituting the tip main body. The melting point of the material constituting the filter is preferably higher by 30° C. or more, and more preferably higher by 100° C. or more than the melting point of the material constituting the tip main body. When such a material is used, for example, the filter can be fused to the lower opening portion by melting the lower opening portion of the lower end of the tip main body with heat and bringing the melted lower opening portion into contact with the filter, and thus the pipette tip of the embodiment of the present invention can be easily produced.

In the pipette tip, preferably, a melting point of a material constituting the filter is higher than a melting point of a material constituting the tip main body, and the filter is fused to the lower opening portion.

The pipette tip is preferably a pipette tip obtained by melting a lower opening portion of a lower end of the tip main body with heat, bringing the melted lower opening into contact with the filter, and fusing the filter to the lower opening portion.

### [Carrier]

The carrier is not particularly limited as long as the carrier is a carrier that is usually held and used in the pipette tip main body.

The carrier is preferably a carrier for adsorbing the substance α or the substance β, and such a carrier may be appropriately selected according to the types of the substance α and the substance β. Details of the substance α and the substance β will be described later.

When a purified solution having increased purity of the substance α or a concentrated solution having increased concentration of the substance α is produced from a sample solution containing the substance α, the carrier has adsorbability for the substance α, and preferably further has non-adsorbability for contaminants. For example, when a purified solution having increased protein purity or a concentrated solution having increased protein concentration is produced from a sample solution containing proteins, the carrier has adsorbability for proteins.

Here, the term “adsorbability” means a property of adsorbing under a specific adsorption condition, and the term “non-adsorbability” means a property of not substantially adsorbing under a specific condition.

Examples of the carrier having adsorbability for proteins include clay, agarose, dextran, hydroxyapatite, silica gel, polystyrene, phenol resin, acrylic resin, polyolefin (for example, polyethylene and polypropylene), polyvinyl chloride, and derivatives thereof. Examples of the derivative of agarose include sepharose, examples of the derivative of dextran include sephadex, and examples of the derivative of hydroxyapatite include carbonate hydroxyapatite. Among these, hydroxyapatite, sepharose, and agarose are preferable, and hydroxyapatite is more preferable.

In particular, examples of the carrier having adsorbability for antibodies include agarose or beads immobilized with proteins derived from bacteria that specifically bind to an antibodies, and as such a carrier, agarose or beads immobilized with Protein A, Protein G, or Protein L can be used. Protein A, Protein G, or Protein L may be a recombinant, or may be a recombinant obtained by removing a region non-specifically binding to an impurity such as albumin and/or a cell wall binding region from Protein A, Protein G, or Protein L.

Examples of the carrier having adsorbability for nucleic acids include hydroxyapatite, silica, magnetic silica beads, cellulose, and agarose or beads immobilized with a complementary strand or a substance having structural affinity for nucleic acids.

Examples of the carrier having adsorbability for lipids include agarose or beads immobilized with Tim4 that binds to phosphatidylserine.

Examples of the carrier having adsorbability for saccharides include an ion exchange resin, activated carbon, agarose or beads immobilized with lectins or sugar chain-recognizing antibodies, boronic acid, and derivatives thereof.

Examples of the carrier having adsorbability for exosomes include agarose or beads immobilized with substances having affinity for molecules expressed on the exosome surface, and more specific examples thereof include agarose or beads immobilized with lipid-binding proteins such as Tim4 that binds to phosphatidylserine, lipid-recognizing antibodies, or lipid-recognizing aptamers; agarose or beads immobilized with antibodies or aptamers that recognize exosome-specific proteins such as CD9 and other proteins from the tetraspanin family; and agarose or beads immobilized with molecules that recognize lectins.

Examples of the carrier having adsorbability for viruses include agarose or beads (for example, agarose or beads immobilized with antibodies or aptamers recognizing viral spike proteins) immobilized with substances having affinity for molecules expressed on the surface of viruses.

When proteins are adsorbed to the carrier, a combination of substances having specific affinity may be used to adsorb proteins. That is, the carrier may be one immobilized with one of combinations of substances having specific affinity via a chemically modifying group. Examples of the combination of substances having specific affinity include an antibody and an antigen, an antibody and an antibody-binding protein, a glutathione-S-transferase (GST) tag and glutathione, a His tag and a divalent cation, and biotin and avidin.

Examples of the carrier having adsorbability for proteins include agarose or a derivative thereof to which an antibody against a specific protein is bound. One type of antibody may be bound to the carrier, or a plurality of types of antibodies may be bound to the carrier. Examples of the carrier to which a plurality of types of antibodies are bound include agarose or a derivative thereof in which a plurality of antibodies are bound to each of several types of proteins (for example, α1-acid glycoprotein, α1-antitrypsin, α2-macroglobulin, albumin, apolipoprotein A-I, apolipoprotein A-II, fibrinogen, haptoglobulin, IgA, IgG, IgM, and transferrin) contained in a large amount in human serum or plasma.

When a purified solution having increased purity of the substance α or a concentrated solution having increased concentration of the substance α is produced from a sample solution containing the substance β, the carrier has adsorbability for the substance β, preferably an encapsulated substance, and may have adsorbability or non-adsorbability for the substance α. For example, when a purified solution having increased nucleic acid purity or a concentrated solution having increased nucleic acid concentration is produced from a sample solution containing a substance containing nucleic acids, the carrier is preferably a carrier having adsorbability for a substance containing nucleic acids, preferably an encapsulated substance, and the carrier may be a carrier having non-adsorbability for nucleic acids or a carrier having adsorbability for nucleic acids.

In addition, when a purified solution having increased purity of the substance α or a concentrated solution having increased concentration of the substance α is produced from a sample solution containing the substance β, in a case where a carrier having adsorbability for the substance α and the substance β is used as the carrier, the adsorbability between the carrier and the substance β may be enhanced more than the adsorbability between the carrier and the substance α, the carrier and the substance β may be adsorbed, and the carrier and the substance o may not be adsorbed by adjusting the conditions when the carrier and the substance β are brought into contact with each other.

Examples of carriers having adsorbability for substances containing nucleic acids, preferably encapsulated substances, and more preferably proteins, as well as adsorbability for nucleic acids, include hydroxyapatite.

When a purified solution having increased nucleic acid purity or a concentrated solution having increased nucleic acid concentration is produced from a sample solution containing viruses, the carrier preferably has adsorbability for at least one selected from proteins, lipids, and sugars constituting the encapsulated substance, and more preferably has adsorbability for proteins. In this case, the carrier may be a carrier having non-adsorbability for nucleic acids or a carrier having adsorbability for nucleic acids.

When a purified solution having increased purity of the substance α which is at least one selected from proteins, lipids, and sugars or a concentrated solution having increased concentration of the substance α which is at least one selected from proteins, lipids, and sugars is produced from a sample solution containing extracellular vesicles such as exosomes, microvesicles, and apoptotic vesicles, the carrier preferably has adsorbability for at least one selected from proteins, lipids, and sugars constituting an encapsulated substance, and more preferably has adsorbability for proteins. In this case, the carrier may be a carrier having non-adsorbability for the substance α or a carrier having adsorbability for the substance α.

When a purified solution having increased purity of viruses, extracellular vesicles, or DDS preparations or a concentrated solution having increased concentration of viruses, extracellular vesicles, or DDS preparations is produced from a sample solution containing a drug delivery system (DDS) preparation such as viruses, extracellular vesicles, liposomes, and lipid nano particles (LNP), the carrier preferably has adsorbability for at least one selected from proteins, lipids, and sugars that constitute the encapsulated substance of the viruses, extracellular vesicles, or DDS preparations, more preferably has adsorbability for lipids, and even more preferably has adsorbability for phospholipids.

When a purified solution having increased purity of extracellular vesicles or a concentrated solution having increased concentration of extracellular vesicles is produced from a sample solution containing extracellular vesicles, the carrier preferably has adsorbability for phosphatidylserine, and is particularly preferably agarose or beads immobilized with lipid-binding proteins such as Tim4 that binds to phosphatidylserine.

Examples of the carrier having adsorbability for phosphatidylserine constituting the encapsulated substance of exosomes include agarose or beads immobilized with a substance having affinity for phosphatidylserine (for example, agarose or beads immobilized with lipid-binding proteins such as Tim4 that binds to phosphatidylserine, lipid-recognizing antibodies, or lipid-recognizing aptamers).

Examples of the carrier having adsorbability for proteins constituting the encapsulated substance of exosomes include agarose or beads immobilized with antibodies or aptamers that recognize exosome-specific proteins, such as CD9 and other proteins from the tetraspanin family.

Examples of the carrier having adsorbability for sugars constituting the encapsulated substance of exosomes include agarose or beads immobilized with molecules that recognize lectins.

When a purified solution having increased purity of the substance α which is at least one selected from nucleic acids, proteins, lipids, and sugars or a concentrated solution having increased concentration of the substance α which is at least one selected from nucleic acids, proteins, lipids, and sugars is produced from a sample solution containing a liposome, the carrier preferably has an adsorbability for lipids constituting the encapsulated substance and has non-adsorbability for the substance α, and the carrier preferably has adsorbability for lipids constituting the encapsulated substance and has non-adsorbability for nucleic acids, proteins, or sugars.

Examples of the carrier having non-adsorbability for nucleic acids and adsorbability for proteins include agarose or beads immobilized with protein-recognizing antibodies.

Examples of the carrier having non-adsorbability for nucleic acids and adsorbability for lipids include agarose or beads immobilized with lipid-binding proteins such as Tim4 or lipid-recognizing antibodies.

Examples of the carrier having non-adsorbability for nucleic acids and adsorbability for saccharides include agarose or beads immobilized with lectins or sugar chain-recognizing antibodies.

Examples of the carrier having non-adsorbability for proteins and adsorbability for lipids include agarose or beads immobilized with lipid-binding proteins such as Tim4 or lipid-recognizing antibodies.

Examples of the carrier having non-adsorbability for proteins and adsorbability for saccharides include agarose or beads immobilized with lectins or sugar chain-recognizing antibodies.

Examples of the carrier having non-adsorbability for lipids and adsorbability for nucleic acids include silica and hydroxyapatite.

Examples of the carrier having non-adsorbability for lipids and adsorbability for proteins include agarose or beads immobilized with antibodies, and hydroxyapatite.

Examples of the carrier having non-adsorbability for lipids and adsorbability for saccharides include agarose or beads immobilized with lectins or sugar chain-recognizing antibodies.

Examples of the carrier having non-adsorbability for saccharides and adsorbability for nucleic acids include silica and hydroxyapatite.

Examples of the carrier having non-adsorbability for saccharides and adsorbability for proteins include agarose or beads immobilized with antibodies, and hydroxyapatite.

Examples of the carrier having non-adsorbability for saccharides and adsorbability for lipids include agarose or beads immobilized with lipid-binding proteins such as Tim4 or lipid-recognizing antibodies.

When viruses or extracellular vesicles are adsorbed to the carrier, the antigen proteins present on the surface of viruses or the extracellular vesicles may be used to adsorb the viruses or extracellular vesicles to the carrier. Examples of the antigenic protein present on the exosome surface include tetraspanins such as CD9, CD63, and CD81; antigen presentation-related proteins such as MHCI and MHCII; adhesion molecules such as integrin, ICAM-1, and EpCAM; cytokines/cytokine receptors such as EGFRvIII and TGF-β; and enzymes.

The carrier may be used alone or in combination of two or more types thereof.

The carrier may have magnetism.

The carrier is preferably a carrier having a magnetic body on the inside of the above-described various carriers having adsorbability for the substance α or the substance β, or a carrier having adsorbability for the substance α or the substance β directly or indirectly by modifying the surface of the magnetic body. Examples of such a carrier include a carrier having magnetic particles in sepharose, a carrier obtained by chemically modifying various biomolecular probes on the surface of dextran-coated magnetic particles, a carrier obtained by introducing various functional groups into magnetic particles, and a carrier obtained by coating polystyrene core particles with a magnetic material and polystyrene. Examples of commercially available products include Mag Sepharose series of Cytiva, Dynabeads series of Thermo Fisher Scientific Inc., SupraBead series of Recenttec K.K., SPHERO magnetic particles series of Spherotech Inc., and Magnetic Micro Beads series of Sigma-Aldrich Co. LLC.

The carrier having magnetism is preferably a carrier having magnetic particles on the inside of sepharose.

The carrier is preferably a carrier having hydroxyapatite or magnetism because the carrier is likely to be dispersed in a liquid and has high strength.

The shape of the carrier is not particularly limited, and examples thereof include a spherical shape, a particulate shape, a fibrous shape, a rod shape, and a plate shape, but a spherical shape and a particulate shape are preferable from the viewpoint of ease of solid-liquid separation and cleaning.

The size of the carrier is not particularly limited as long as the carrier is larger than the pores of the filter, and varies depending on the type of the substance α, but when the carrier is spherical or particulate, the average particle size thereof is preferably 0.5 μm to 2 mm, more preferably 1 μm to 1.5 mm, and still more preferably 1 μm to 1 mm. In addition, the method for measuring the average particle size can be performed using a light scattering method.

The density of the carrier is not particularly limited, but is preferably more than 1 g/cm³ and more preferably 2.5 to 3.5 g/cm³.

The amount of the carrier held in the tip main body is not particularly limited, and may be appropriately selected according to, for example, the capacity of the tip main body, the type of the carrier, the type of the sample solution, or the amounts of the substance α and the substance β in the sample solution.

The amount of the carrier held in the tip main body is preferably less than 100% and more preferably 95% or less when the amount of the carrier when the total horizontal projected area of the carrier and the area of the filter are equal in a case where the carriers are uniformly arranged in one layer on the filter is 100%.

### [Substance α and Substance β]

The substance α is a substance that is contained in a sample solution and is to be purified or concentrated.

The substance α and the substance β contained in the sample solution may be one type or two or more types. In addition, the substance α contained in the concentrated solution may be one type or two or more types.

The substance α is not particularly limited, and examples thereof include proteins; nucleic acids; lipids; saccharides; extracellular vesicles such as exosomes, microvesicles, and apoptotic vesicles; viruses; and drug delivery system (DDS) preparations such as liposomes and lipid nano particles (LNP), and these may be labeled with, for example, a fluorescent dye, biotin, a reporter enzyme, or a radioisotope.

The substance α is preferably a biological substance (for example, proteins; nucleic acids; lipids; saccharides; extracellular vesicles such as exosomes, microvesicles, and apoptotic vesicles; and viruses), more preferably a protein or an exosome, and still more preferably an exosome.

The protein is not particularly limited, and examples thereof include simple proteins such as albumin, globulin, keratin, collagen, and fibroin; and complex proteins such as glycoproteins, phosphoproteins, chromoproteins, and nucleoproteins. Among these, simple proteins are preferable.

The protein may be an antibody (immunoglobulin), a contractile protein, an enzyme, a hormonal protein, a structural protein, a storage protein, or a transport protein, and is preferably an antibody (immunoglobulin) or a transport protein.

The nucleic acid is not particularly limited, and examples thereof include DNA, RNA, microRNA, and mRNA.

The lipid is not particularly limited, and is, for example, a simple lipid such as glyceride, sterol ester, wax, or ceramide; complex lipids such as phospholipids and glycolipids; and derived lipids such as fatty acids, terpenoids, steroids, and carotenoids.

The saccharide is not particularly limited, and examples thereof include monosaccharides such as glucose and fructose; disaccharides such as maltose, sucrose, and lactose; polysaccharides such as starch, cellulose, and glycogen; and glycans that are added to proteins and lipids in eukaryotes and present as components of the complex.

The aspect of the substance β is not particularly limited as long as the substance β contains the substance α, and the substance β is preferably a substance in which the substance α is contained on the inside of an encapsulated substance.

The encapsulated substance is, for example, a capsule-like substance that encapsulates at least a part of the substance α.

The substance β is present only when the substance α is a protein, a nucleic acid, a lipid, or a saccharide. That is, the substance α in the substance β is a protein, a nucleic acid, a lipid, or a saccharide.

For example, when a concentrated solution having increased exosome concentration is produced from a sample solution containing an exosome, the exosome is the substance α. In addition, when a concentrated solution having increased nucleic acid concentration is produced from a sample solution containing an exosome, the nucleic acid is the substance α and the exosome is the substance β. The substance α and the substance β are distinguished according to what is to be purified or concentrated.

Examples of the substance in which the substance α is contained in the encapsulated substance include viruses; extracellular vesicles such as exosomes, microvesicles, and apoptotic vesicles; and drug delivery system (DDS) preparations such as liposomes and lipid nano particle (LNP). The substance β is preferably a virus or an exosome.

In the virus, nucleic acids are contained in an encapsulated substance (for example, capsid and envelope) composed of at least one selected from proteins, lipids, and sugars.

In the extracellular vesicle, at least one selected from nucleic acids, proteins, lipids, and sugars is contained in an encapsulated substance composed of at least one selected from proteins, lipids, and sugars.

Examples of the extracellular vesicles include exosomes, microvesicles, and apoptotic vesicles, and among these, exosomes are preferable.

In the liposome, at least one selected from nucleic acids, proteins, lipids, and sugars is contained in an encapsulated substance (for example, a lipid bilayer) composed of lipids.

In the LNP, at least one selected from nucleic acids, proteins, lipids, and sugars is contained in an encapsulated substance (for example, a lipid monolayer or a lipid bilayer composed of, for example, ionized lipids, helper lipids, or PEG lipids) composed of lipids.

### [Sample Solution]

The sample solution is not particularly limited as long as the sample solution is a liquid that may contain the substance α or the substance β. Examples of the sample solution include biological samples, microorganisms or cell samples, food, environmental samples, and liquids obtained by diluting these with a diluent.

Examples of the biological sample include animal and plant tissues, body fluids, excretions, and swab fluids, cleaning solutions, and cultures thereof. More specific examples include blood, plasma, serum, blood culture solution, urine, saliva, amniotic fluid, pus, cerebrospinal fluid, pleural effusion, pharyngeal swab fluid, nasal swab fluid, nasopharyngeal swab fluid, nasal discharge, sputum, rectal swab fluid, tissue section, skin, vomit, feces, myringotomy fluid, alveolar lavage fluid, gastric lavage fluid, intestinal lavage fluid, cervical swab fluid, urethral abrasion, organ extract, and tissue extract.

According to one aspect of the present invention, since it is possible to concentrate the substance α even when a biological sample containing a large amount of contaminants is targeted, the biological sample is preferably blood, urine, saliva, a pharyngeal swab fluid, a nasal swab fluid, a nasopharyngeal swab fluid, nasal discharge, or sputum, and among these, a sample derived from a mammal, particularly, derived from a human is more preferable.

The microorganisms or cell samples may be, for example, transformants into which recombinant vectors for expressing proteins of interest is introduced, or hybridomas in which a plurality of cells are fused, in addition to naturally derived microorganisms or cells. Further, in addition to the microorganisms or cells themselves, a microorganism or cell lysates and culture supernatants are also included.

Examples of the microorganism or cell include fungi such as yeast and mold, prokaryotic microorganisms such as E. coli, and cultured cells such as plant cells, insect cells, and animal cells, and E. coli and animal cells are preferable.

As the microorganism or cell sample, an animal cell sample is preferable, and a culture supernatant of animal cells is more preferable. The animal cell may be derived from any animal, but is preferably derived from a mammal, and the animal cell may be a primary cell or an established cell, or may be derived from such as an iPS cell or an ES cell. In the present specification, the mammal is preferably human, cow, dog, cat, pig, miniature pig, rabbit, hamster, rat, or mouse, and more preferably human.

Examples of the food include water, alcoholic beverages, soft drinks, processed foods, vegetables, livestock products, marine products, eggs, dairy products, raw meat, raw fish, and side dishes. When a food is used as a sample, not only a part or all of the food can be used, but also a product obtained by wiping the surface of the food can be used. Furthermore, a product obtained by wiping a food contact portion or a human contact portion of a cooking utensil, for example, or a cleaning solution obtained by cleaning the food contact portion or the human contact portion can also be used as the sample. For a sample containing a large amount of liquid components, a sample obtained by performing, for example, drying, ultrafiltration, or distillation to remove a part or all of the liquid components may be used as necessary.

Examples of the environmental sample include water, ice, and soil. Examples of the water herein include water collected from various sources, such as tap water, seawater, rivers, waterfalls, lakes, and ponds. In addition, a sample obtained by wiping, for example, human contact portions such as door knobs, facility wall surfaces, floor surfaces, equipment, fixtures, or toilets, or a cleaning solution obtained by cleaning these can also be used as the sample. For a sample containing a large amount of liquid components, a sample obtained by performing, for example, drying, ultrafiltration, or distillation to remove a part or all of the liquid components may be used as necessary.

The diluent is not particularly limited, and examples thereof include water and a buffer solution. As the buffer solution, for example, a buffer solution usually used in a biochemical test can be used, and examples thereof include a Tris buffer solution and a phosphate buffer solution. The diluent contains, for example, a salt such as sodium chloride; surfactants such as SDS; metal chelating agents such as EDTA; and preservatives such as sodium azide can be appropriately added.

The diluent may be, for example, a culture medium for culturing microorganisms or cells. The diluent is preferably a culture medium for cell culture, and more preferably a culture medium containing no animal-derived serum.

The method for collecting the sample solution is not particularly limited, and a known method can be used according to the type and purpose of the sample solution. Examples of the collection method include a collection method using collection tools such as cotton swabs, swabs, inoculation loops, pipettes, spatulas, scoops, and syringes.

The amount of the sample solution is not particularly limited, and may be determined according to the capacity of the pipette tip main body.

When the sample solution is a cell culture supernatant, since there is a tendency that the amount of components derived from dead cells is small, a cell culture supernatant obtained after culturing cells for 12 hours to 7 days is preferable, and a cell culture supernatant obtained after culturing cells for 24 hours to 5 days is more preferable. The cell culture supernatant may be used after being diluted, for example, 2 to 5 times with the medium used for cell culture.

### [Method for Producing Concentrated Solution]

One aspect of the present invention is a method for producing a concentrated solution having increased concentration of a substance α from a sample solution containing a target substance (substance α) or a substance α-containing substance (substance β) using the pipette tip, and the method includes: a step A of sucking and discharging the sample solution through a lower opening portion of a lower end of the pipette tip to adsorb the substance α or the substance β to the carrier; and a step B of sucking and discharging a releasing solution to release the substance α from the carrier, thereby obtaining a concentrated solution having increased concentration of the substance α.

### Step A

Step A is a step of sucking and discharging the sample solution through the lower opening portion of the lower end of the pipette tip to adsorb the substance α or the substance β to the carrier.

In the step A, the substance α or the substance β in the sample solution diffuses in the sample solution, passes through the filter, reaches the inside of the tip main body, and is adsorbed to the carrier in the tip main body. Since this series of flows is repeated not once but a plurality of times, the substance α or the substance β is more likely to be adsorbed to the carrier. Therefore, it is possible to easily produce a concentrated solution having more increased concentration of the substance α.

The suction and discharge speed is not particularly limited, and the suction and discharge speeds may be the same or different.

At the time of suction, carriers are dispersed in the sample solution, and a state similar to that of batch chromatography is obtained. Therefore, when the suction speed is high, carriers are likely to be dispersed, and an advantage similar to that of batch chromatography is likely to be obtained. Therefore, the suction speed is preferably higher than the discharge speed.

At the time of discharge, the sample solution is delivered from the top to the bottom of the carrier accumulated on the filter, and becomes in the same state as in the column chromatography. Therefore, when the discharge speed is slow, the substance α or the substance β is likely to be adsorbed to the carrier, and the same advantage as in the column chromatography is likely to be obtained. Therefore, the discharge speed is preferably lower than the suction speed.

Suction and discharge may be performed continuously, or an interval may be provided between suction and discharge. However, it is preferable to provide an interval between suction and discharge. When an interval is provided between suction and discharge, it is possible to wait for a certain amount of carriers dispersed by suction to accumulate on the filter. Therefore, the sample solution is delivered from the top to the bottom of a larger amount of accumulated carriers, and is likely to be in the same state as in column chromatography, and the substance α or the substance β is likely to be adsorbed to the carriers.

The volume to be sucked and discharged is preferably 1% or more, more preferably 10% or more, still more preferably 50% or more, and particularly preferably 70% or more of the sample solution.

The suction and discharge are preferably performed at a frequency of 1 time/min or more, more preferably 1.5 times/min or more, and still more preferably 2 times/min or more, and is preferably performed for 10 minutes to 24 hours, more preferably 15 minutes to 12 hours, and still more preferably 30 minutes to 1 hour.

When the suction and discharge are performed under the above conditions, the substance α and the substance β can be efficiently adsorbed to the carrier.

The instrument or apparatus that performs the suction and discharge is not particularly limited, and for example, a pipette such as a micropipette, a macropipette, a measuring pipette, or a Komagome pipette can be used, but from the viewpoint of safety and contamination prevention, a micropipette or a macropipette is preferable.

The instrument or apparatus that performs the pipetting operation may be manual or electric, but an electric pipette is preferable because the pipetting operation can be accurately performed.

### Step B

Step B is a step of obtaining a concentrated solution having increased concentration of the substance α by sucking and discharging a releasing solution to release the substance α from the carrier.

The method for performing step B is not particularly limited.

The releasing solution is a liquid capable of releasing the substance α from the carrier.

The composition and properties, for example, of the releasing solution are not limited as long as the substance α can be released from the carrier.

When releasing the substance α from the carrier, for example, in a case where a substance in which the substance α is contained on the inside of the encapsulated substance is used as the substance β, the encapsulated substance adsorbed to the carrier may or may not be released from the carrier, and in a case where the encapsulated substance is also released from the carrier, a separation operation between the substance α and the encapsulated substance may be required, and thus it is preferable not to release the substance α from the carrier because such a separation operation is omitted. Specifically, it is preferable to release the substance α by bringing the liquid (for example, nucleic acid extract) capable of releasing the substance α (for example, nucleic acid) into the liquid from the substance β (for example, encapsulated substance containing nucleic acid) adsorbed to the carrier into contact with the carrier.

When the substance α is adsorbed to the carrier, the substance α can be released from the carrier by changing the adsorbability of the carrier for the substance α.

For example, when the protein is adsorbed to hydroxyapatite, examples of the liquid capable of releasing the protein from hydroxyapatite include a metal chelating agent such as EDTA of 100 mM or more, a surfactant such as SDS or Triton X-100, and an aqueous solution of, for example, phosphoric acid of 100 mM or more. These may be used alone, or in combination of two or more types thereof.

When the substance β is a substance in which the substance α is contained in the encapsulated substance, the substance o can be released from the substance β adsorbed to the carrier into the liquid by modifying or breaking the encapsulated substance. For example, when viruses or exosomes in which nucleic acids are contained in proteins are adsorbed to a carrier, the nucleic acids can be released from the viruses or exosomes adsorbed to the carrier by using the releasing solution containing a protein denaturant.

Examples of the protein denaturant include surfactants such as SDS and Triton X-100; chaotropic agents such as guanidine thiocyanate, guanidine hydrochloride, urea and NaI; protease such as Proteinase K; and organic solvents such as phenol. These may be used alone, or in combination of two or more types thereof. The protein denaturant may be, for example, a nuclease inhibitor such as EDTA; a reducing agent such as 2-mercaptoethanol or DTT may be used in combination. As the protein denaturant, for example, TRIzol Reagent, QIAzol Lysis Reagent, or ISOGEN commercially available as a nucleic acid extraction reagent may be used.

For example, when viruses, extracellular vesicles, or DDS preparations are adsorbed to agarose or beads (carrier) immobilized with substances having affinity for molecules expressed on the surface of viruses, extracellular vesicles, or DDS preparations, the viruses, the extracellular vesicles, or the DDS preparations can be released from the carrier by changing a binding state between the molecule expressed on the surface of the viruses, the extracellular vesicles, or the DDS preparations and the substances having affinity.

For example, when the exosomes are adsorbed to agarose or beads (carrier) immobilized with lipid-binding proteins such as Tim4 that binds to phosphatidylserine expressed on the exosome surface, lipid-recognizing antibodies, or lipid-recognizing aptamers, the exosomes can be released from the carrier by changing the binding state of lipid-binding proteins such as Tim4, lipid-recognizing antibodies, or lipid-recognizing aptamers. Examples of the liquid capable of releasing the exosomes from the carrier include metal chelating agents such as EDTA in an amount of 0.5 mM or more.

By releasing the viruses, extracellular vesicles, or DDS preparations from the carrier in this manner, a purified solution can be produced from a sample solution containing the viruses, extracellular vesicles, or DDS preparations, which contain the viruses, extracellular vesicles, or DDS preparations in an intact state and have an increased purity of the viruses, extracellular vesicles, or DDS preparations.

The amount of the releasing solution used is not particularly limited as long as the substance α can be sufficiently released from the carrier, but is usually smaller than the amount of the sample solution used such that the concentration of the substance α contained in the concentrated solution can be further increased.

As the releasing solution, a plurality of different releasing solutions may be sequentially brought into contact with the carrier. Accordingly, it is possible to further increase the concentration of the substance α contained in the concentrated solution.

In addition, the releasing solution after being brought into contact with the carrier may be brought into contact with the carrier again. Accordingly, it is possible to further increase the concentration of the substance α contained in the concentrated solution.

The volume to be sucked and discharged is preferably 50% or more, more preferably 60% or more, and still more preferably 70% or more of the releasing solution.

The suction and discharge are preferably performed at a frequency of 1 time/min or more, more preferably 1.5 times/min or more, and still more preferably 2 times/min or more, and is preferably performed for 10 minutes to 24 hours, more preferably 15 minutes to 12 hours, and still more preferably 30 minutes to 1 hour.

When the suction and discharge are performed under the above conditions, the substance α and the substance β can be efficiently released from the carrier.

The instrument or apparatus that performs the suction and discharge is not particularly limited, and for example, a pipette such as a micropipette, a macropipette, a measuring pipette, or a Komagome pipette can be used, but from the viewpoint of safety and contamination prevention, a micropipette or a macropipette is preferable.

The instrument or apparatus that performs the pipetting operation may be manual or electric, but an electric pipette is preferable because the pipetting operation can be accurately performed.

### (Cleaning Step)

The method for producing a concentrated solution preferably includes a step of cleaning the carrier with a cleaning solution after step A and before step B. Hereinafter, this step is also referred to as “cleaning step”.

The contaminants not adsorbed to the carrier are likely to adhere to and remain on such as the wall, the filter, and the carrier in the tip main body. By the cleaning step, contaminants can be more efficiently removed.

The method for performing the cleaning step is not particularly limited, but the operation is simple and copes with an automation apparatus, the method is preferably performed by a sucking and discharging the cleaning solution.

The cleaning solution is not particularly limited as long as it is difficult to release the substance α from the carrier, and examples thereof include water and a buffer solution. As the buffer solution, for example, a buffer solution usually used in a biochemical test can be used, and examples thereof include a Tris buffer solution and a phosphate buffer solution. The cleaning solution may contain, as appropriate, salts such as sodium chloride; surfactants such as SDS; metal chelating agents such as EDTA; and preservatives such as sodium azide, according to the type and amount of contaminants. For example, when a concentrated solution having increased nucleic acid concentration is produced from a sample solution containing viruses, preferably using hydroxyapatite as a carrier, free nucleic acids derived from substances other than viruses can be removed by performing the cleaning step using a cleaning solution containing EDTA.

The amount of the cleaning solution is not particularly limited. The volume of the cleaning solution may be appropriately determined according to the type and amount of contaminants, and is preferably 20 times or more, more preferably 100 times or more, and still more preferably 200 times or more the volume of the carrier.

As the cleaning solution, a plurality of different cleaning solutions may be sequentially used. Thus, contaminants can be efficiently removed, and the purity of the substance α contained in the concentrated solution can be further increased.

The method for producing the concentrated solution can produce the concentrated solution having increased concentration of the target substance from a sample solution containing the target substance or the target substance-containing substance only by the suction/discharge operation, and thus is suitable for use in a robot liquid handler in which the operation of detaching the pipette tip is automated in addition to the operation of sucking and discharging the liquid. The robot liquid handler may be a nucleic acid automatic purification device or a protein automatic purification device, and examples of such an automatic purification device include Purelumn System (manufactured by Precision System Science Co., Ltd.), Assist Plus (manufactured by Integra Biosciences Ltd.), and CyBio Felix (manufactured by Analytik Jena GmbH+Co. KG).

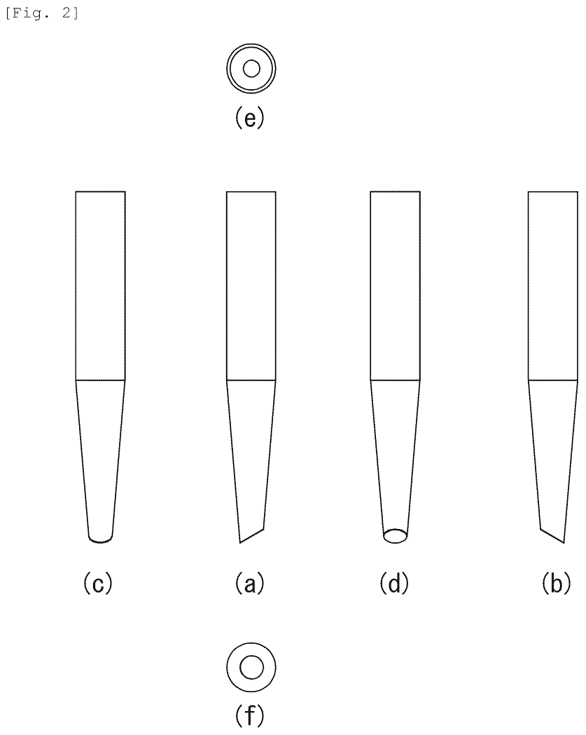

FIG. 2 is a six-sided view of the pipette tip according to the first embodiment. That is, FIG. 2A is a front view of the pipette tip, FIG. 2B is a rear view of the pipette tip, FIG. 2C is a left side view of the pipette tip, FIG. 2D is a right side view of the pipette tip, FIG. 2E is a plan view of the pipette tip, and FIG. 2F is a bottom view of the pipette tip.

In addition, FIG. 3 is a perspective view of the pipette tip according to the first embodiment illustrated in FIG. 2. That is, FIG. 3A is a perspective view of the pipette tip as viewed from the plane side, and FIG. 3B is a perspective view of the pipette tip as viewed from the bottom surface side.

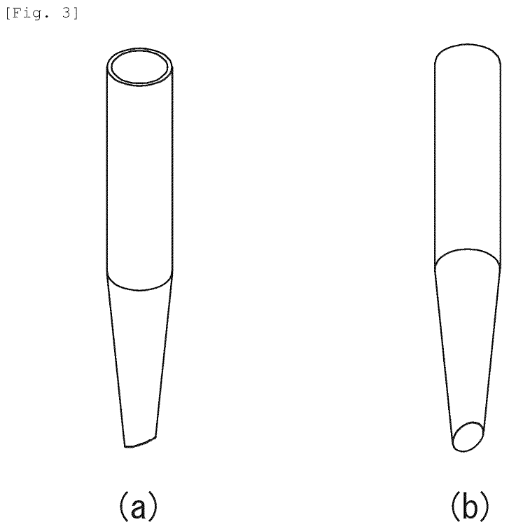

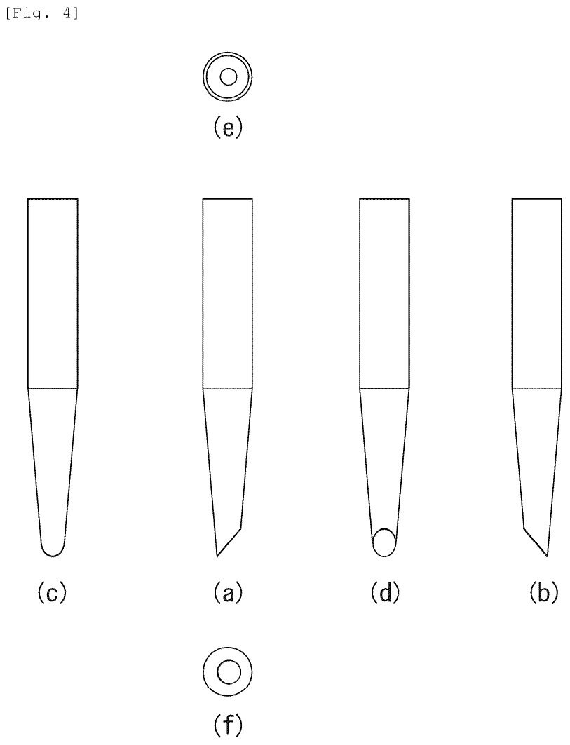

FIG. 4 is a six-sided view of the pipette tip according to a second embodiment. That is, FIG. 4A is a front view of the pipette tip, FIG. 4B is a rear view of the pipette tip, FIG. 4C is a left side view of the pipette tip, FIG. 4D is a right side view of the pipette tip, FIG. 4E is a plan view of the pipette tip, and FIG. 4F is a bottom view of the pipette tip.

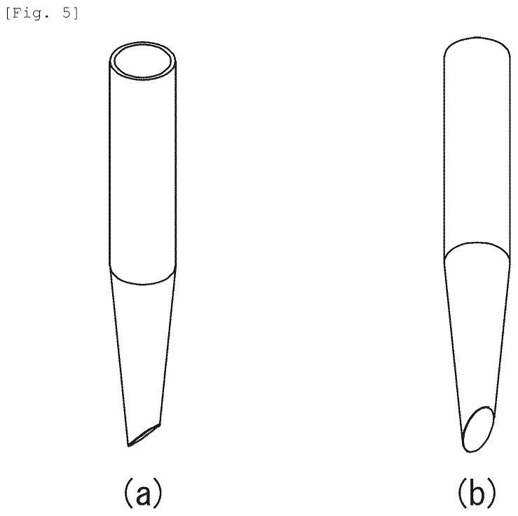

In addition, FIG. 5 is a perspective view of a pipette tip according to the second embodiment illustrated in FIG. 4. That is, FIG. 5A is a perspective view of the pipette tip as viewed from the plane side, and FIG. 5B is a perspective view of the pipette tip as viewed from the bottom surface side.

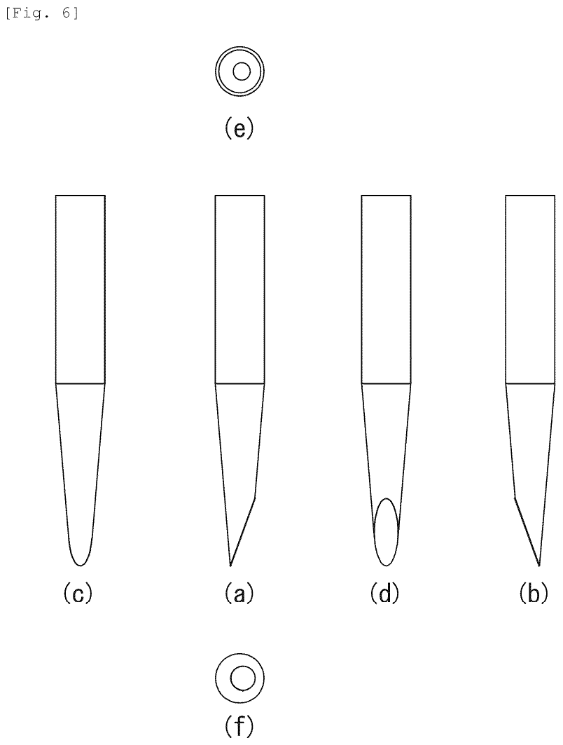

FIG. 6 is a six-sided view of the pipette tip according to a third embodiment. That is, FIG. 6A is a front view of the pipette tip, FIG. 6B is a rear view of the pipette tip, FIG. 6C is a left side view of the pipette tip, FIG. 6D is a right side view of the pipette tip, FIG. 6E is a plan view of the pipette tip, and FIG. 6F is a bottom view of the pipette tip.

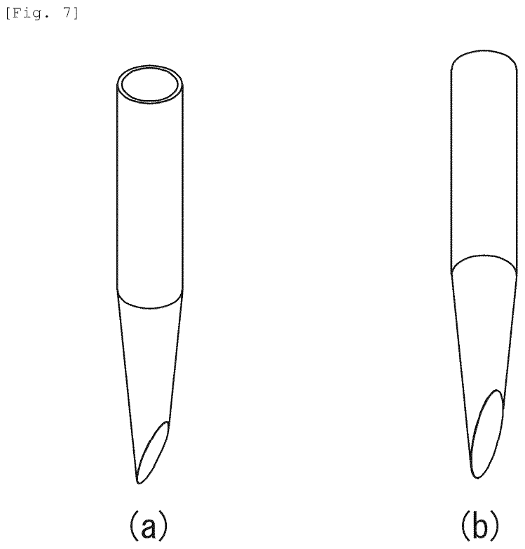

In addition, FIG. 7 is a perspective view of a pipette tip according to the third embodiment illustrated in FIG. 6. That is, FIG. 7A is a perspective view of the pipette tip as viewed from the plane side, and FIG. 7B is a perspective view of the pipette tip as viewed from the bottom surface side.

FIG. 8 is a six-sided view of the pipette tip according to a fourth embodiment. That is, FIG. 8A is a front view of the pipette tip, FIG. 8B is a rear view of the pipette tip, FIG. 8C is a left side view of the pipette tip, FIG. 8D is a right side view of the pipette tip, FIG. 8E is a plan view of the pipette tip, and FIG. 8F is a bottom view of the pipette tip.

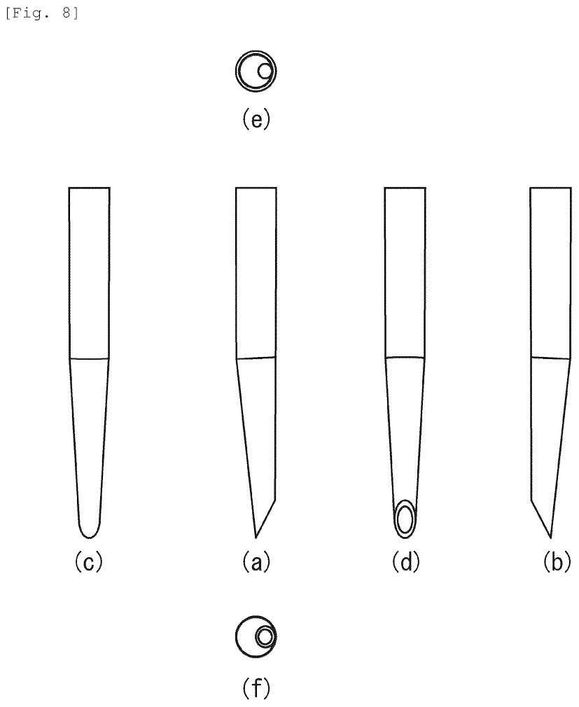

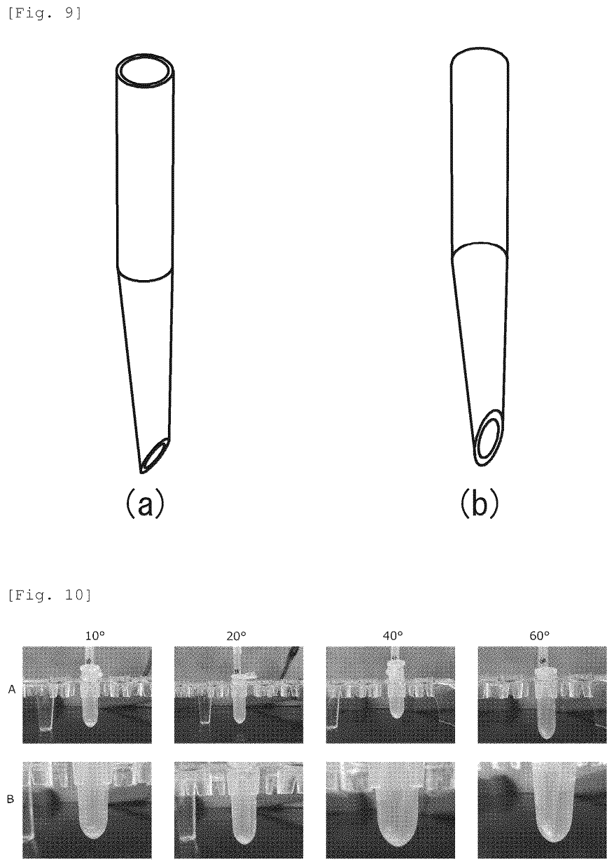

In addition, FIG. 9 is a perspective view of a pipette tip according to a fourth embodiment illustrated in FIG. 8. That is, FIG. 9A is a perspective view of the pipette tip as viewed from the plane side, and FIG. 9B is a perspective view of the pipette tip as viewed from the bottom surface side.

In the pipette tip according to the fourth embodiment, the lowermost end of the tip main body is formed on the axis of the tip main body.

In FIGS. 2 to 9, for the sake of simplicity, the carrier is not described.

### EXAMPLES

Next, the present invention will be described in more detail with reference to examples, but the present invention is not limited thereto.

### <Preparation of Pipette Tip> (Preparation of Filter)

A nonwoven fabric (weight: 24 g/m², 300 mm×20 mm, average pore size: 1 μm) composed of PTFE ultrafine fibers was immersed in a 99.7% isopropyl alcohol (IPA) solution (manufactured by FUJIFILM Wako Pure Chemical Corporation) for 30 minutes at room temperature (25° C.).

Next, the PTFE filter taken out from the IPA solution was immersed in 500 mL of a polyvinyl alcohol (PVA) (manufactured by FUJIFILM Wako Pure Chemical Corporation, 160-11485, polymerization degree: 1500, saponification degree: 98%) aqueous solution adjusted to a concentration of 0.1 mass % at room temperature for 30 minutes.

Thereafter, the PTFE filter taken out from the PVA aqueous solution was immersed in a mixed liquid obtained by mixing 500 mL of a 5 mass % glutaraldehyde solution (a solution prepared by diluting a 25% glutaraldehyde solution manufactured by FUJIFILM Wako Pure Chemical Corporation with pure water to adjust a concentration to 5 mass %) and 5 ml of a 36% aqueous hydrochloric acid solution (manufactured by FUJIFILM Wako Pure Chemical Corporation) at room temperature for 30 minutes.

Next, the PTFE filter taken out from the mixed liquid was put into pure water to dissolve unreacted IPA, PVA, and glutaraldehyde.

The PTFE filter taken out from the pure water was vacuum-dried at 80° C. for 240 minutes, and then impregnated with an MPC (2-methacryloyloxyethyl phosphorylcholine) polymer solution (physical adsorption type MP011 L1 MPC polymer ethanol solution manufactured by Intelligent Surface, Inc.) at room temperature for 1 minute.

The PTFE filter taken out from the polymer solution was vacuum-dried at 80° C. for 120 minutes and then immersed in cleaning water for 180 minutes. Thereafter, the PTFE filter taken out from the liquid was vacuum-dried at 80° C. for 240 minutes to obtain an MPC polymer-applied hydrophilicized PTFE filter.

(Preparation of Pipette Tip with Filter)

A pipette tip (manufactured by Thermo Fisher Scientific Inc., Cat. NO. 94410813) was cut using an ultrasonic cutter. At this time, the inclination angle of the cut surface was set to a specific angle with respect to a line orthogonal to the axis of the pipette tip in a front view of the pipette tip. The MPC polymer-applied hydrophilicized PTFE filter was pressed against the cut surface of the pipette tip to temporarily install the filter. In this state, the cut surface was pressed downward to a hot plate heated to 180° C. to perform heat fusion. The material constituting the pipette tip main body is polypropylene, the melting point of polypropylene is about 160° C., and the melting point of PTFE is about 320° C.

Pipette tips shown in Table 1 were prepared by changing the inclination angle of the cut surface.

TABLE 1

| | Inclination angle of cut surface |
|---|---|
| | (In a front view of pipette tip, an angle |
| | made by the cut surface and the line |
| | orthogonal to the axis of pipette tip) |
| Production Example 1 | 10° |
| Production Example 2 | 20° |
| Production Example 3 | 40° |
| Production Example 4 | 50° |
| Production Example 5 | 60° |
| Production Example 6 | 65° |
| Production Example 7 | 70° |

In addition, the main body of the pipette tip (manufactured by Thermo Fisher Scientific Inc., Cat. NO. 94410813) was cut at a position of 17 mm from the lower end such that the cut surface was orthogonal to the axis of the pipette tip (in a front view of the pipette tip, an angle formed by a cut surface and a line orthogonal to an axis of the pipette tip is) 0°, and the MPC polymer-applied hydrophilicized PTFE filter was heat-fused to the cut surface in the same manner as described above to prepare Comparative Production Example 1.

In Production Examples 1 to 7, in order to eliminate the influence of the filter area, the position from the lower end of the cut surface was adjusted to obtain the same filter area as that of Comparative Production Example 1.

### Experimental Example 1

Using a micropipette, 10 μL of HT carrier particles (Bio-Gel HT Hydroxyapatite manufactured by Bio-Rad Laboratories, Inc., model number: 130-0150) adjusted to 12.5 mass % slurry with PBS buffer was added into the pipette tips of Comparative Production Example 1 and Production Example 6 from the upper end of the pipette tip to obtain pipette tips of Comparative Example 1 and Example 1, respectively.

An automatic pipettor (manufactured by Thermo Fisher Scientific Inc., E1-ClipTip electric pipette, model number: 4670040BT) was connected to the upper ends of the pipette tips of Comparative Example 1 and Example 1. Furthermore, the lower end of the pipette tip was placed in a U-bottom 2 mL tube (manufactured by Eppendorf, NO. 0030108450) containing 1 mL of purified water, and the solution in the tube was disposed to be sucked. Note that the arrangement of the container (tube) and the automatic pipettor is a representation of an automation apparatus including only pipetting device for sucking and discharging a solution and means for moving the pipetting device up and down and back and forth.

The suction amount of the automatic pipettor was set to 1 mL, and the suction and discharge of the solution was attempted in the manual mode.

Whether the solution was sucked and discharged or dispersion of the carrier associated with the suction/discharge operation (a state where the carrier was stirred up) was visually observed, and photographs and moving images were taken.

In the pipette tip of Example 1, the solution was smoothly sucked and discharged, and the carrier in the pipette tip was efficiently dispersed by suction and discharge. In addition, dispersion of the carrier by suction and discharge could be repeatedly performed.

In the pipette tip of Comparative Example 1, in order to completely suck the solution in the container (tube), it was necessary that the filter surface at the tip end of the pipette tip was in contact with or close to the U-shaped bottom of the tube, and when the filter surface at the tip end of the pipette tip was not in contact with or close to the U-shaped bottom of the tube, it was difficult to suck and discharge the solution. In particular, suction and discharge with a small amount of liquid was impossible.

### Experimental Example 2

An automatic pipettor (manufactured by Thermo Fisher Scientific Inc., E1-ClipTip electric pipette, model number: 4670040BT) was connected to the upper ends of the pipette tips of Comparative Example 1 and Example 1. Further, the lower end of the pipette tip was placed in a petri dish having a flat bottom diameter of 3.5 cm (manufactured by NUNC, NO. 153066) containing 7 mL of purified water, and the pipette tip was disposed such that the solution in the petri dish could be sucked. The suction amount of the automatic pipettor was set to 1 mL, and the suction and discharge of the solution was attempted in the manual mode.

Whether the solution was sucked and discharged or dispersion of the carrier associated with the suction/discharge operation (a state where the carrier was stirred up) was visually observed, and photographs and moving images were taken.

In the pipette tip of Example 1, the solution was smoothly sucked and discharged, and the carrier in the pipette tip was efficiently dispersed by suction and discharge. In addition, dispersion of the carrier by suction and discharge could be repeatedly performed.

In the pipette tip of Comparative Example 1, the solution was sucked, and the carrier in the pipette tip was dispersed by suction, but the sucked solution could not be discharged. Therefore, it was not possible to repeatedly suck and discharge the solution.

### Experimental Example 3

An automatic pipettor (manufactured by Thermo Fisher Scientific Inc., E1-ClipTip electric pipette, model number: 4670040BT) was connected to the upper ends of the pipette tips of Comparative Example 1 and Example 1. Further, the lower end of the pipette tip was placed in a U-bottom 2 mL tube (manufactured by Eppendorf, NO. 0030108450) containing 1 mL of the BSA-Cy3 solution prepared below, and the solution in the tube was disposed to be sucked.

In the custom mode of the automatic pipettor, bovine serum albumin (BSA) labeled with a Cy3 fluorescent dye was adsorbed to HT carrier particles by sucking and discharging 1 mL of the solution at a speed of Speed 3 for 1 hour.

The BSA-Cy3 solution was prepared as follows.

A Cy3 fluorescent dye (manufactured by Amersham plc, model number: Q13108) was added to a bovine serum albumin solution (manufactured by Sigma-Aldrich Co. LLC, 100 μg/10 μL, solvent: H₂O), and the mixture was reacted at room temperature in the dark for 1 hour. Thereafter, TBS was added to stop the reaction, and the mixture was allowed to stand at room temperature for 1 hour in the dark. Next, gel filtration (manufactured by Thermo Fisher Scientific Inc., model number: 89883) was performed to remove excess Cy3 fluorescent dye. Bovine serum albumin solution (BSA-Cy3 solution) (25 μg/mL) labeled with a Cy3 fluorescent dye was prepared by dilution with PBS (manufactured by TakaRa Bio Inc., model number: T900).

After repeating suction and discharge at room temperature for 30 minutes, the liquid in the pipette tip was discharged, and then the tube was replaced. Specifically, the tube used for adsorption of BSA-Cy3 was removed, and a pipette tip was disposed such that a solution in a new tube containing 1 mL of PBS (manufactured by TakaRa Bio Inc., model number: T900) as a wash buffer could be sucked.

In the custom mode of the automatic pipettor, the HT carrier particles were cleaned by sucking and discharging 1 mL of the solution once at a speed of Speed 3.

After suction and discharge, the liquid in the pipette tip was discharged, and then the tube was replaced. Specifically, the tube used for cleaning was removed, and a pipette tip was disposed such that the solution in a new tube containing 50 μL of Elute buffer (5 M guanidine thiocyanate (manufactured by FUJIFILM Wako Pure Chemical Corporation, model number: 077-04995), 100 mM EDTA aqueous solution (pH 8.0, manufactured by Nippon Gene Co., Ltd., model number: 311-90075), and 100 mM Tris-HCl (pH 6.8): Tris (manufactured by FUJIFILM Wako Pure Chemical Corporation, model number: 200-07887), which were pH-adjusted with hydrochloric acid (manufactured by FUJIFILM Wako Pure Chemical Corporation, model number: 080-01066), 3% Triton X-100 (Nacalai Tesque Inc., 35501-15), 1% 2-mercaptoethanol (manufactured by Sigma-Aldrich Co. LLC, model number: M3148) could be sucked.

In the custom mode of the automatic pipettor, by sucking and discharging 0.2 mL of the solution at room temperature for 5 minutes at a speed of Speed 1, bovine serum albumin labeled with a Cy3 fluorescent dye adsorbed to the HT carrier particles was released from the HT carrier particles, and the obtained liquid was defined as Elute.

When the Elute buffer was sucked and discharged, the solution was sucked and discharged, or the dispersion of the carrier (the state where the carrier was stirred up) and the color change of the solution associated with the suction/discharge operation were visually observed, and photographs and moving images were taken.

In the pipette tip of Example 1, since the tip end of the pipette tip was close to the solution surface or in point contact with the solution surface, the solution was smoothly sucked and discharged, and the carrier in the pipette tip was efficiently dispersed by suction and discharge. In addition, dispersion of the carrier by suction and discharge could be repeatedly performed. Furthermore, since the pink color of the solution gradually became more intense along with the suction and discharge, it was confirmed that bovine serum albumin labeled with the Cy3 fluorescent dye was released from the HT carrier particles.

The fluorescence values of the BSA-Cy3 solution as a sample solution and Elute were measured with a Qubit 4 Fluorometer (manufactured by Thermo Fisher Scientific Inc., model number: Q33226, blue mode (470 nm)), and as a result, the BSA-Cy3 solution was 2748, and the Elute was 28720. That is, Elute was about 10 times more intensely pink than the BSA-Cy3 solution as a sample solution, and it was possible to produce a concentrated solution in which BSA-Cy3 was concentrated about 10 times by using the pipette tip of Example 1.

In the pipette tip of Comparative Example 1, since the tip end of the pipette tip was in flush contact with the solution surface, the solution could not be sucked and discharged, and bovine serum albumin labeled with a Cy3 fluorescent dye could not be reproducibly adsorbed to the HT carrier particles. In particular, at the time of elution with a solution amount of 50 μL, suction and discharge of the liquid became unstable, and the results varied.

### Experimental Example 4

Using a micropipette, 10 μL of HT carrier particles (Bio-Gel HT Hydroxyapatite manufactured by Bio-Rad Laboratories, Inc., model number: 130-0150) adjusted to 12.5 mass % slurry with PBS buffer was added into the pipette tips of Production Examples 1, 2, 3, and 5 from the upper end of the pipette tip to obtain pipette tips of Examples 2, 3, 4, and 5, respectively.

An automatic pipettor (manufactured by Thermo Fisher Scientific Inc., E1-ClipTip electric pipette, model number: 4670040BT) was connected to the upper ends of the pipette tips of Examples 2, 3, 4, and 5. Further, the lower end of the pipette tip was placed in a U-bottom 2 mL tube (manufactured by Eppendorf, NO. 0030108450) containing 1 mL of ultrapure water, and the pipette tip was disposed such that the solution in the tube could be sucked.

In the custom mode of the automated pipettor, 1 mL of solution was sucked and discharged at a speed of Speed 3 for 30 minutes.

Whether the solution was sucked and discharged or dispersion of the carrier associated with the suction/discharge operation (a state where the carrier was stirred up) was visually observed, and photographs and moving images were taken.

The photographs taken are shown in FIGS. 10 and 11.

In the pipette tips of Examples 2, 3, 4, and 5, the solution was smoothly sucked and discharged, and the carrier in the pipette tip was efficiently dispersed by suction and discharge. In addition, dispersion of the carrier by suction and discharge could be repeatedly performed.

In the pipette tip of Example 2 (inclination angle 10°), the carrier was stirred up in the solution along with the suction of the solution, but no swirling of the carriers was observed. The carrier precipitated in the solution along with the discharge of the solution, and accumulated on the filter to uniformly cover the entire surface of the filter.

In the pipette tip of Example 3 (inclination angle 20°), the carrier was stirred up in the solution along with the suction of the solution, but no swirling of the carriers was observed. The carrier precipitated in the solution along with the discharge of the solution, and accumulated on the filter to uniformly cover the entire surface of the filter.

In the pipette tip of Example 4 (inclination angle 40°), when the carrier was stirred up in the solution along with the suction of the solution, swirling of the carriers was observed, it was considered that a turbulent flow occurred along with the suction of the solution, but the turbulent flow was weak. The carrier precipitated in the solution along with the discharge of the solution, and accumulated on the filter to uniformly cover the entire surface of the filter. After the discharge, the position of the carrier on the filter changed toward the lowermost end of the pipette tip due to gravity until the next suction, and the carrier covered only a part of the filter surface.

In the pipette tip of Example 5 (inclination angle 60°), when the carrier was stirred up in the solution along with the suction of the solution, strong swirling of the carriers was clearly observed, and it was considered that a turbulent flow occurred along with the suction of the solution. The carrier accumulated on the filter to uniformly cover the entire surface of the filter along with the discharge of the solution.

However, the position of the carrier on the filter changed toward the lowermost end of the pipette tip due to gravity, and the carrier covered only a part of the filter surface.

A conceptual diagram of a dispersion state of the carrier in the pipette tip of Example 5 is shown in FIG. 12. When the carrier was stirred up in the solution along with the suction of the solution, strong swirling of the carriers was clearly observed (State 1), and it was considered that a turbulent flow occurred along with the suction of the solution. The carrier precipitated in the solution along with the discharge of the solution (State 2), and accumulated on the filter to uniformly cover the entire surface of the filter (State 3). After the discharge, the position of the carrier on the filter changed toward the lowermost end of the pipette tip due to gravity until the next suction, and the carrier covered only a part of the filter surface (State 4).

### Experimental Example 5

Using a micropipette, 10 μL of HT carrier particles (Bio-Gel HT Hydroxyapatite manufactured by Bio-Rad Laboratories, Inc., model number: 130-0150) adjusted to 12.5 mass % slurry with PBS buffer was added into the pipette tip of Production Example 7 from the upper end of the pipette tip to obtain a pipette tip of Example 6.

An automatic pipettor (manufactured by Thermo Fisher Scientific Inc., E1-ClipTip electric pipette, model number: 4670040BT) was connected to the upper ends of the pipette tips of Examples 1, 4, and 6. Further, the lower end of the pipette tip was placed in a U-bottomed 2 mL tube (manufactured by Eppendorf, NO. 0030108450) containing 1 mL of the BSA-Cy3 solution, and the solution in the tube was disposed to be sucked.

In the custom mode of the automatic pipettor, bovine serum albumin labeled with a Cy3 fluorescent dye was adsorbed to HT carrier particles by sucking and discharging 1 mL of the solution at a speed of Speed 3 for 30 minutes.

After suction and discharge, the liquid in the pipette tip was discharged, and then the tube was replaced. Specifically, the tube used for adsorption of BSA-Cy3 was removed, and a pipette tip was disposed such that a solution in a new tube containing 1 mL of PBS (manufactured by TakaRa Bio Inc., model number: T900) as a wash buffer could be sucked.

In the custom mode of the automatic pipettor, the HT carrier particles were cleaned by sucking and discharging 1 mL of the solution once at a speed of Speed 3.

After cleaning, the liquid in the pipette tip was discharged, and then the tube was replaced. Specifically, the tube used for cleaning was removed, and a pipette tip was disposed such that the solution in a new tube containing 50 μL of purified water could be sucked.

When dispersion of the carrier associated with the suction/discharge operation (a state where the carrier was stirred up) was visually observed, and photographs and moving images were taken.

The photographs taken are shown in FIG. 13.

In the pipette tips of Examples 1, 4, and 6, the solution was smoothly sucked and discharged, and the carrier in the pipette tip was efficiently dispersed by suction and discharge. In addition, dispersion of the carrier by suction and discharge could be repeatedly performed.

In the pipette tip of Example 4 (inclination angle 40°), when the carrier was stirred up in the solution along with the suction of the solution, swirling of the carriers was observed, it was considered that a turbulent flow occurred along with the suction of the solution, but the turbulent flow was weak. The carrier precipitated in the solution along with the discharge of the solution, and accumulated on the filter to uniformly cover the entire surface of the filter. After the discharge, the position of the carrier on the filter changed toward the lowermost end of the pipette tip due to gravity until the next suction, and the carrier covered only a part of the filter surface.

In the pipette tip of Example 1 (inclination angle 65°), when the carrier was stirred up in the solution along with the suction of the solution, strong swirling of the carriers was clearly observed, and it was considered that a turbulent flow occurred along with the suction of the solution. The carrier precipitated in the solution along with the discharge of the solution and accumulated on the filter to uniformly cover the entire surface of the filter. However, after the discharge, the position of the carrier on the filter changed toward the lowermost end of the pipette tip due to gravity until the next suction, and the carrier covered only a part of the filter surface.

In the pipette tip of Example 6 (inclination angle 70°), when the carrier was stirred up in the solution along with the suction of the solution, strong swirling of the carriers was clearly observed, and it was considered that a turbulent flow occurred along with the suction of the solution. The carrier precipitated in the solution along with the discharge of the solution and accumulated on the filter to uniformly cover the entire surface of the filter. However, after the discharge, the position of the carrier on the filter changed toward the lowermost end of the pipette tip due to gravity until the next suction, and the carrier covered only a part of the filter surface. A part of the carrier near the lowermost end of the tip was not stirred up even when the solution was sucked, and remained near the lowermost end of the tip even when the solution was repeatedly sucked and discharged.

A conceptual diagram of a dispersion state of the carrier in the pipette tip of Example 6 is shown in FIG. 12. When the carrier was stirred up in the solution along with the suction of the solution, strong swirling of the carriers was clearly observed (State 1), and it was considered that a turbulent flow occurred along with the suction of the solution. The carrier precipitated in the solution along with the discharge of the solution (State 2), and accumulated on the filter to uniformly cover the entire surface of the filter (State 3). After the discharge, the position of the carrier on the filter changed toward the lowermost end of the pipette tip due to gravity until the next suction, and the carrier covered only a part of the filter surface (State 4). A part of the carrier near the lowermost end of the tip was not stirred up even when the solution was sucked, and remained near the lowermost end of the tip even when the solution was repeatedly sucked and discharged (State 5).

### (Experimental Example 6) (Production Example 8)

A pipette tip (manufactured by GILSON, NO. D10 mL) was cut using an ultrasonic cutter. At this time, the inclination angle of the cut surface was set to 55° with respect to a line orthogonal to the axis of the pipette tip in a front view of the pipette tip. The pipette tip was cut again in the same manner to have a V shape in front view, and a second cut surface was created. The MPC polymer-applied hydrophilicized PTFE filter was pressed against the cut surface of the pipette tip to temporarily install the filter. In this state, the cut surface was pressed downward to a hot plate heated to 180° C. to perform heat fusion. The second cut surface was also heat-fused with an MPC polymer-applied hydrophilicized PTFE filter in the same manner. This was used as a pipette tip of Production Example 8.

Using a micropipette, 50 μL of carrier particles (Streptavidin Mag Sepharose manufactured by Cytiva, model number: 28985738, 10 mass % slurry) was added into the pipette tip of Production Example 8 from the upper end of the pipette tip to obtain a pipette tip of Example 7.

An automatic pipettor (manufactured by GILSON, model number: P10mLM, for 10 mL) was connected to the upper end of the pipette tip of Example 7. Further, the lower end of the pipette tip was placed in a U-bottom 14 mL tube (manufactured by Falcon Corporation, NO. 352057) containing 50 μL of purified water, and the pipette tip was disposed such that the solution in the tube could be sucked.

In the custom mode of the automated pipettor, 200 μL of solution was sucked and discharged at a speed of Speed 3.

Whether the solution was sucked and discharged or dispersion of the carrier associated with the suction/discharge operation (a state where the carrier was stirred up) was visually observed, and photographs and moving images were taken.

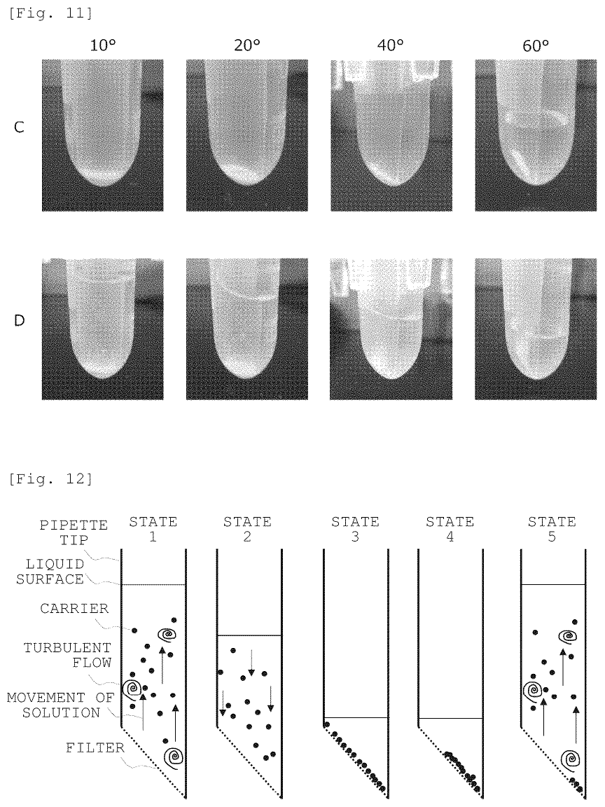

The photographs taken are shown in FIG. 14.

In the pipette tip of Example 7, the solution was smoothly sucked and discharged, and the carrier in the pipette tip was efficiently dispersed by suction and discharge. In addition, dispersion of the carrier by suction and discharge could be repeatedly performed. In Experimental Example 6, since the amount of the used solution was small, a part of the filter was not immersed in the solution, but the solution was sucked and discharged from the filter tip through a part of the filter immersed in the solution. In an existing filter tip, when the entire filter is not immersed in a solution, bubbles often enter the liquid in the tip from a part of the filter that is not immersed in the solution at the time of suction, which causes a problem in subsequent suction and discharge. However, in the filter tip of Example 7, bubbles did not enter the liquid in the tip, and no problem occurred in the subsequent suction and discharge.

### (Experimental Example 7) (Preparation of Cell Culture Supernatant)

Capan-2, which is a cultured cell derived from pancreatic cancer, was used as an exosome supply source cell to conduct an experiment to concentrate exosomes from cell culture supernatant. Conventionally, it has been known that culture supernatants such as adipocytes include exosomes, and, for example, adipocytes have been widely used as supply source cells for exosomes. However, Capan-2, which is a pancreatic cancer-derived culture cell, was used as an exosome supply source cell this time.

For culturing Capan-2 cells, a CELLSTAR flask manufactured by Greiner Bio-One, 25 cm² (690170) and a serum-containing medium (D-MEM medium (manufactured by FUJIFILM Wako Pure Chemical Corporation, #044-29765), 10% Fetal Bovine Serum (manufactured by Thermo Fisher Scientific Inc. (Gibco), #10270106), and 1% Penicillin-Streptomycin (manufactured by Thermo Fisher Scientific Inc. (Gibco), #15140122)) were used.

Fetal Bovine Serum used for normal cell culture includes bovine-derived exosomes. In order to prevent mixing of the bovine-derived exosomes into the cell culture supernatant, Capan-2 cells were cultured in a serum-free medium (D-MEM medium (manufactured by FUJIFILM Wako Pure Chemical Corporation, #044-29765) and 1% Penicillin-Streptomycin (manufactured by Thermo Fisher Scientific Inc. (Gibco), #15140122) from the middle of the culture period. Specifically, the culture supernatant was removed from a flask of Capan-2 cells grown to a confluent state in a serum-containing medium, and subsequently a cell cleaning operation (an operation of adding 10 mL of serum-free medium to the flask, cleaning the cells, and then immediately removing the medium) was performed 5 times. Subsequently, 10 mL of a serum-free medium was added to the flask and cultured at 37° C. and a 5% CO₂ concentration for 48 hours.

After 48 hours of culture, the flask was erected and 20 mL of serum-free medium was added to make the total amount 30 mL. This was defined as Input.

### (Preparation of Tip)

Using a micropipette, 10 μL of exosome collection carrier particles (Streptoavidin Mag Sepharose manufactured by Cytiva, model number: 28985738) combined with 1 μL of biotin-labeled exosome capture contained in MagCapture Exosome Isolation Kit PS Ver. 2 (manufactured by FUJIFILM Wako Pure Chemical Corporation, model number: 294-84101) was added into the pipette tips of Production Examples 3, 5 and 7 from the upper end of the pipette tip to obtain pipette tips of Examples 8, 9, and 10, respectively.

An automatic pipettor (manufactured by Thermo Fisher Scientific Inc., model number: E1-ClipTip electric pipette, for 1, 250 μL) was connected to the upper ends of the pipette tips of Examples 8, 9, and 10. Further, the lower end of the pipette tip was placed in a U-bottom 2 mL tube (manufactured by Eppendorf, NO. 0030108450) containing 1 mL of a culture supernatant (Input) of Capan-2, to which 2 μL of Exosome Binding Enhancer (500×) contained in MagCapture Exosome Isolation Kit PS Ver. 2 (manufactured by FUJIFILM Wako Pure Chemical Corporation, model number: 294-84101) was added, and the solution in the tube was disposed to be sucked.

In the custom mode of the automatic pipettor, 1 mL of the solution was sucked and discharged at a speed of Speed 1 for 1 hour, and the exosome in the culture supernatant was adsorbed to the carrier.

Thereafter, the liquid in the pipette tip was discharged (the discharged solution was considered as Through), and then the tube was replaced. Specifically, the tube used for adsorption of the exosome was removed, and a pipette tip was disposed such that a solution in a new tube containing 1 mL of Exosome Immobilizing/Washing Buffer contained in MagCapture Exosome Isolation Kit PS Ver. 2 (manufactured by FUJIFILM Wako Pure Chemical Corporation, model number: 294-84101) could be sucked.

In the custom mode of the automatic pipettor, the carrier particles were cleaned by sucking and discharging 1 mL of the solution once at a speed of Speed 1. The tube was replaced with a new tube containing 1 mL of Exosome Immobilizing/Washing Buffer to perform suction and discharge, and the cleaning operation was repeated three times in total.

After cleaning, the liquid in the pipette tip was discharged, and then the tube was replaced. Specifically, the tube used for cleaning was removed, and a pipette tip was disposed such that a solution in a new tube containing 50 μL of Elution buffer (20 mM Tris-HCl (pH 7.6): Tris (manufactured by FUJIFILM Wako Pure Chemical Corporation, model number: 200-07887), which was pH-adjusted with hydrochloric acid (manufactured by FUJIFILM Wako Pure Chemical Corporation, model number: 080-01066), 150 mM NaCl (manufactured by FUJIFILM Wako Pure Chemical Corporation, model number: 191-01665), 2 mM EDTA (Nippon Gene Co. Ltd., model number: 311-90075), and 1% Triton X-100 (Nacalai Tesque Inc., 35501-15) could be sucked.

In the custom mode of the automatic pipettor, the exosome component was eluted from the carrier particles by sucking and discharging 50 μL of the solution at room temperature for 10 minutes at a speed of Speed 1. The obtained eluate was defined as Elute.

In each step of adsorption, cleaning, and elution, dispersion of the carrier (a state where the carrier was stirred up) associated with the suction/discharge operation was visually observed, and photographs and moving images were taken.

As a control experiment, the exosome was concentrated by existing batch chromatography using a 2 mL tube (FIG. 15 illustrates “Tube”).

10 μL of exosome capture carrier particles (10 μL of Streptoavidin Mag Sepharose manufactured by Cytiva, (model number: 28985738) combined with 1 μL of biotin-labeled exosome capture contained in MagCapture Exosome Isolation Kit PS Ver. 2 (manufactured by FUJIFILM Wako Pure Chemical Corporation, model number: 294-84101) (10% slurry)) and 1 mL of a culture supernatant (Input) of Capan-2, to which 2 μL of Exosome Binding Enhancer (500×) contained in MagCapture Exosome Isolation Kit PS Ver. 2 (manufactured by FUJIFILM Wako Pure Chemical Corporation, model number: 294-84101) was added, were added into a U-bottomed 2 mL tube (manufactured by Eppendorf, NO. 0030108450), and the mixture was mixed by inversion at room temperature for 1 hour using a mixer (manufactured by TOHO KK., model number: RM-2M), and then the carrier particles were separated using a magnetic bar. The liquid in the tube after separation was considered as Through.

The separated carrier particles were cleaned 3 times with 1 mL of Exosome Immobilizing/Washing Buffer contained in MagCapture Exosome Isolation Kit PS Ver. 2 (manufactured by FUJIFILM Wako Pure Chemical Corporation, model number: 294-84101), and then 50 μL of Elution buffer (20 mM Tris-HCl (pH 7.6): Tris (manufactured by FUJIFILM Wako Pure Chemical Corporation, model number: 200-07887), which was pH-adjusted with hydrochloric acid (manufactured by FUJIFILM Wako Pure Chemical Corporation, model number: 080-01066), 150 mM NaCl (manufactured by FUJIFILM Wako Pure Chemical Corporation, model number: 191-01665), 2 mM EDTA (Nippon Gene Co. Ltd., model number: 311-90075), and 1% Triton X-100 (Nacalai Tesque Inc., 35501-15) were used to elute the exosome components from the carrier particles. The obtained eluate was defined as Elute.

The confirmation of the exosome concentrated from the culture supernatant of Capan-2 cells was performed by Western blot of CD9, which is a marker of the exosome. 50 μL of the eluate (Elute) was mixed with a sample buffer (manufactured by FUJIFILM Wako Pure Chemical Corporation, #198-13282) not containing a reducing agent, treated at 100° C. for 5 minutes, and then developed by SDS-PAGE.

As a comparative control, 50 μL of an input sample was subjected to the same treatment.

As a gel for SDS-PAGE, SuperSep™ Ace, 10 to 20% (manufactured by FUJIFILM Wako Pure Chemical Corporation, #191-15031) was used. After electrophoresis, the developed sample was transferred from the gel to a PVDF membrane (Trans-Blot Turbo Mini 0.2 μm PVDF Transfer Packs, manufactured by Bio-Rad Laboratories, Inc., #1704156), and the PVDF membrane was blocked for 1 hour at room temperature using PVDF Blocking Reagent for Can Get Signal (manufactured by TOYOBO Co., Ltd., #NYPBR01). As the detection antibody, anti-Human CD9 (COSMO BIO, #SHI-EXO-M01) as a primary antibody and anti-Mouse IgG-HRP (GE, #NA931) as a secondary antibody were diluted 1,000 times and 5,000 times with Can Get Signal Solution (manufactured by TOYOBO Co., Ltd., #NKB-101), respectively, and used. The reactions were each performed at room temperature for 1 hour. Immobilon Forte (manufactured by MilliporeSigma, #WBLUF0100) was used as a detection reagent, and a signal was detected by LuminoGraph1 (manufactured by ATTO Corporation).

In the pipette tip of Example 8 (inclination angle 40°), when the carrier was stirred up in the solution along with the suction of the solution, swirling of the carriers was observed, it was considered that a weak turbulent flow occurred along with the suction of the solution. The carrier precipitated in the solution along with the discharge of the solution, and accumulated on the filter to uniformly cover the entire surface of the filter. After the discharge, the position of the carrier on the filter changed toward the lowermost end of the pipette tip due to gravity until the next suction, and the carrier covered only a part of the filter surface.

In the pipette tip of Example 9 (inclination angle 60°), when the carrier was stirred up in the solution along with the suction of the solution, strong swirling of the carriers was clearly observed, and it was considered that a turbulent flow occurred along with the suction of the solution. The carrier precipitated in the solution along with the discharge of the solution and accumulated on the filter to uniformly cover the entire surface of the filter. However, after the discharge, the position of the carrier on the filter changed toward the lowermost end of the pipette tip due to gravity until the next suction, and the carrier covered only a part of the filter surface.

In the pipette tip of Example 10 (inclination angle 70°), when the carrier was stirred up in the solution along with the suction of the solution, strong swirling of the carriers was clearly observed, and it was considered that a turbulent flow occurred along with the suction of the solution. The carrier precipitated in the solution along with the discharge of the solution and accumulated on the filter to uniformly cover the entire surface of the filter. However, after the discharge, the position of the carrier on the filter changed toward the lowermost end of the pipette tip due to gravity until the next suction, and the carrier covered only a part of the filter surface. A part of the carrier near the lowermost end of the tip was not stirred up even when the solution was sucked, and remained near the lowermost end of the tip even when the solution was repeatedly sucked and discharged.

The results of the Western blot are shown in FIG. 15. A band around 25 kDa is a band of CD9 which is an exosome-specific marker.

In Example 8 (17_40°), Example 9 (18_60°), and Example 10 (19_70°), the band of Through was thinner than that of the control experiment (20_Tube), and it was revealed that by using the pipette tips of Examples 8, 9, and 10, the exosome was more likely to be adsorbed to the carrier as compared with the existing batch method.

In addition, in Example 8(17_40°), Example 9 (18_60°), and Example 10 (19_70°), the band of Elute was darker than that in the control experiment (20_Tube), and it was revealed that a concentrated solution having a higher exosome concentration was obtained by using the pipette tips of Examples 8, 9, and 10 as compared with the existing batch method.

In the pipette tips of Example 8 (inclination angle 40°), Example 9 (inclination angle 60°), and Example 10 (inclination angle 70°), the carrier after starting suction and discharge of the solution appeared to be larger than the original size. This is considered to be an aggregate in which a plurality of carriers having a particle size larger than that of the exosome is aggregated around the exosome when the carrier adsorbs the exosome in the solution.

When a plurality of carriers having a particle size larger than that of the substance α or the substance β is aggregated around the substance α or the substance β to form aggregates, the aggregates are likely to be clogged in the column, and thus it is difficult to purify the substance α by general column chromatography, particularly by a column tip.

However, with the pipette tips of Example 8 (inclination angle 40°), Example 9 (inclination angle 60°), and Example 10 (inclination angle 70°), the exosome could be purified and concentrated even when aggregates were formed.

### Experimental Example 8

Using a micropipette, 10 μL of exosome collection carrier particles (Streptoavidin Mag Sepharose manufactured by Cytiva, model number: 28985738) combined with 1 μL of MagCapture Exosome Isolation Kit PS Ver. 2 (manufactured by FUJIFILM Wako Pure Chemical Corporation, biotin-labeled exosome capture contained model number 294-84101) (10% slurry) was added into the pipette tip of Production Example 4 from the upper end of the pipette tip to obtain a pipette tip of Example 11.

An automatic pipettor (manufactured by Thermo Fisher Scientific Inc., model number: E1-ClipTip electric pipette, for 1, 250 μL) was connected to the upper ends of the pipette tips of Examples 9 and 11. Further, the lower end of the pipette tip was placed in a U-bottomed 2 mL tube (manufactured by Eppendorf, NO. 0030108450) containing 1 μL of the culture supernatant of Capan-2, and the solution in the tube was disposed to be sucked.

As the culture supernatant of Capan-2, the case where the culture supernatant of Capan-2 (Input) used in Experimental Example 7 was used was referred to as “Capan-2 stock solution”, and the case where the culture supernatant of Capan-2 (Input) used in Experimental Example 7 was diluted 5 times with a serum-free medium and used was referred to as “Capan-2_1/5 dilution Input”. In the custom mode of the automatic pipettor, 1 mL of the solution was sucked and discharged at a speed of Speed 1 for 30 minutes, and the exosome in the culture supernatant was adsorbed to the carrier.

The control experiment, cleaning, elution, and Western blot of the exosome-binding carrier were performed in the same manner as in Experimental Example 7.

The control experiment was performed with N=4, and the pipette tips of Examples 9 and 11 were performed with N=2.

In each step of adsorption, cleaning, and elution, dispersion of the carrier (a state where the carrier was stirred up) associated with the suction/discharge operation was visually observed, and photographs and moving images were taken.

In the pipette tip of Example 9 (inclination angle 60°), when the carrier was stirred up in the solution along with the suction of the solution, strong swirling of the carriers was clearly observed, and it was considered that a turbulent flow occurred along with the suction of the solution. The carrier precipitated in the solution along with the discharge of the solution and accumulated on the filter to uniformly cover the entire surface of the filter. However, after the discharge, the position of the carrier on the filter changed toward the lowermost end of the pipette tip due to gravity until the next suction, and the carrier covered only a part of the filter surface.

In the pipette tip of Example 11 (inclination angle of 50°), when the carrier was stirred up in the solution along with the suction of the solution, strong swirling of the carriers was clearly observed, and it was considered that a turbulent flow occurred along with the suction of the solution. The carrier precipitated in the solution along with the discharge of the solution and accumulated on the filter to uniformly cover the entire surface of the filter. However, after the discharge, the position of the carrier on the filter changed toward the lowermost end of the pipette tip due to gravity until the next suction, and the carrier covered only a part of the filter surface.

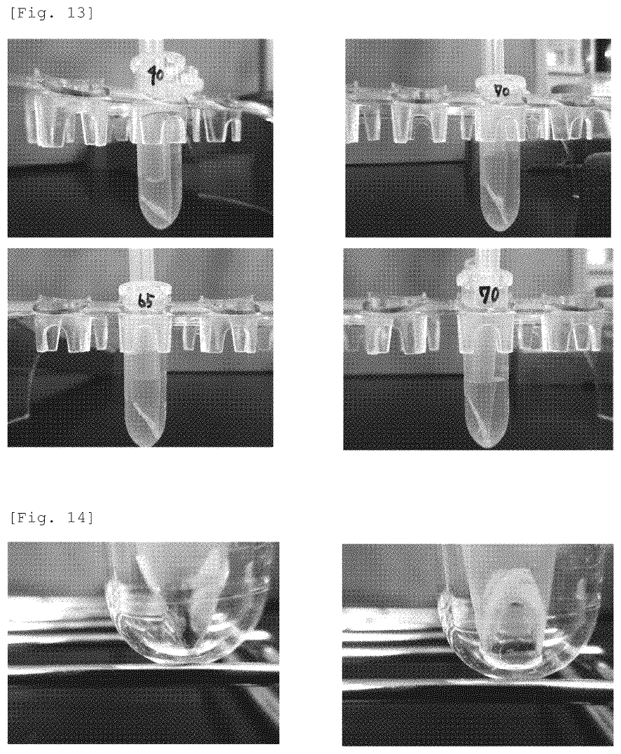

The results of the Western blot are shown in FIG. 16. A band around 25 kDa is a band of CD9 which is an exosome-specific marker.

From FIG. 16, it can be seen that the band of Through was thinly detected in the control experiment (Tube), but the band of Through was below the detection limit in Example 9 (7_Used 60°, 8_Used 60°) and Example 11 (5_Used 50°, 6_Used 50°), and most of the exosome in the culture supernatant was adsorbed to the carrier and hardly remained in the culture supernatant. It was revealed that by using the pipette tips of Examples 9 and 11, the exosome is more likely to be adsorbed to the carrier as compared with the existing batch method.

In addition, the band of Elute is darker in the control experiment (1_Tube, 2_Tube, 3_Tube, 4_Tube) than in “Capan-2_1/5 dilution Input”, and even in the control experiment (1_Tube, 2_Tube, 3_Tube, 4_Tube), which is an existing batch method, a concentrated solution having increased exosome concentration is obtained. On the other hand, in Example 9 (7_Used 60°, 8_Used 60°) and Example 11 (5_Used 50°, 6_Used 50°), bands significantly darker than those in the control experiment (1_Tube, 2_Tube, 3_Tube, 4_Tube) were detected, and it was revealed that by using the pipette tips of Example 9 (inclination angle 60°) and Example 11 (inclination angle 50°), even when a solution having low exosome concentration was used, a concentrated solution having remarkably high exosome concentration was obtained as compared with the existing batch method. When the density of the detected bands was quantified, bands about 4.9 times and about 4.6 times thicker than “Capan-2_1/5 dilution Input” were detected in Examples 9 and 11, respectively. By using the pipette tips of Example 9 (inclination angle 60°) and Example 11 (inclination angle 50°), it was possible to produce a concentrated solution in which the exosome in the sample solution was concentrated about 4.6 times or more.

In Example 9 (inclination angle 60°) and Example 11 (inclination angle 50°), the size of the carrier after starting suction and discharge of the solution appeared larger than the original size. This is considered to be an aggregate in which a plurality of carriers having a particle size larger than that of the exosome is aggregated around the exosome when the carrier adsorbs the exosome in the solution.

When a plurality of carriers having a particle size larger than that of the substance α or the substance β is aggregated around the substance α or the substance β to form aggregates, the aggregates are likely to be clogged in the column, and thus it is difficult to purify the substance α by general column chromatography, particularly by a column tip.

However, with the pipette tips of Example 9 (inclination angle 60°) and Example 11 (inclination angle 50°), the exosome could be purified and concentrated even when aggregates were formed.

### Experimental Example 9

A pipette tip (manufactured by GILSON, model number: D10 mL) was cut using an ultrasonic cutter. At this time, the inclination angle of the cut surface was set to 50° with respect to a line orthogonal to the axis of the pipette tip in a front view of the pipette tip. A hydrophilic PTFE filter was installed on a hot plate heated to 180°, and the tip was pressed against the hot plate while the cut surface of the tip was parallel to the hot plate to perform thermal fusion. A case where a filter having a pore size of 5 μm (manufactured by Millipore Corporation, Omnipore, JMWP09025) was used as the hydrophilic PTFE filter was defined as a pipette tip of Production Example 9, and a case where a filter having a pore size of 10 μm (manufactured by Millipore Corporation, Omnipore, JCWP14225) was used as a pipette tip of Production Example 10.

Using a micropipette, 10 μL of exosome collection carrier particles (Streptoavidin Mag Sepharose manufactured by Cytiva, model number: 28985738) combined with 1 μL of MagCapture Exosome Isolation Kit PS Ver. 2 (manufactured by FUJIFILM Wako Pure Chemical Corporation, biotin-labeled exosome capture contained in model number 294-84101) (10% slurry) was added into the pipette tips of Production Examples 9 and 10 from the upper end of the pipette tip to obtain pipette tips of Examples 12 and 13.

An automatic pipettor (manufactured by Thermo Fisher Scientific Inc., model number: E1-ClipTip electric pipette, for 1, 250 μL) was connected to the upper ends of the pipette tips of Examples 12 and 13. 1 mL of a 1/5 diluted culture supernatant of Capan-2 with TBS and 2 μL of 1 mM CaCl₂) were placed in a U-bottom 2 mL tube (manufactured by Eppendorf, NO. 0030108450). The lower end of the pipette tip was disposed such that the solution in the tube could be sucked.

In the custom mode of the automatic pipettor, 1 mL of the solution was sucked and discharged at a speed of Speed 3 for 30 minutes, and the exosome in the culture supernatant was adsorbed to the carrier.

Cleaning of the exosome-binding carrier was performed three times with 1 mL of MOPS Wash Buffer.

Elution was performed with 50 μL of Elute Buffer (20 mM MOPS (347 08243 manufactured by Dojindo Laboratories), 150 mM NaCl (manufactured by FUJIFILM Wako Pure Chemical Corporation, model number: 191-01665), 2 mM EDTA (Nippon Gene Co. Ltd., NO. 311-90075), and 1% Triton X-100 (Nacalai Tesque Inc., NO. 35501-15)).

For the control experiment, cleaning, elution, and Western blot of the exosome-binding carrier, other conditions were performed in the same manner as in Experimental Example 7.

The control experiment was performed with N=1, and the pipette tips of Examples 12 and 13 were performed with N=2.

In each step of adsorption, cleaning, and elution, dispersion of the carrier (a state where the carrier was stirred up) associated with the suction/discharge operation was visually observed.

In the pipette tips of Examples 12 and 13 (inclination angle of 50°), when the carrier was stirred up in the solution along with the suction of the solution, strong swirling of the carriers was clearly observed, and it was considered that a turbulent flow occurred along with the suction of the solution. The carrier precipitated in the solution along with the discharge of the solution and accumulated on the filter to uniformly cover the entire surface of the filter. However, after the discharge, the position of the carrier on the filter changed toward the lowermost end of the pipette tip due to gravity until the next suction, and the carrier covered only a part of the filter surface.

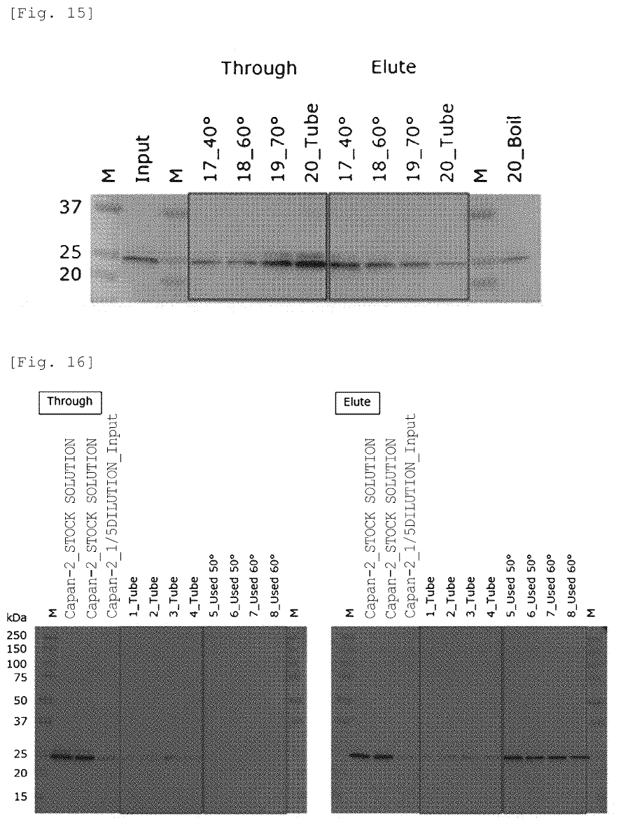

The results of the Western blot are shown in FIG. 17. A band around 25 kDa is a band of CD9 which is an exosome-specific marker.

In Example 12 (1_5 μm, 2_5 μm) and Example 13 (3_10 μm, 4_10 μm), the band of Through was thinner than that of the control experiment (5_Tube), and it was revealed that by using the pipette tips of Examples 12 and 13, the exosome was more likely to be adsorbed to the carrier as compared with the existing batch method.

In addition, in Example 12 (1_5 μm, 2_5 μm) and Example 13 (3_10 μm, 4_10 μm), the band of Elute was darker than that in the control experiment (5_Tube), and it was revealed that by using the pipette tips of Examples 12 and 13, a concentrated solution having higher exosome concentration was obtained as compared with the existing batch method. In particular, in Example 12 (1_5 μm, 2_5 μm) using a filter having a pore size of 5 μm, a concentrated solution having extremely high exosome concentration was obtained.

### Experimental Example 10

The main body of the pipette tip (manufactured by GILSON, NO. D10 mL) was cut at a position of 20 mm from the lower end using an ultrasonic cutter. At this time, the inclination angle of the cut surface was set to 55° with respect to a line orthogonal to the axis of the pipette tip in a front view of the pipette tip. The MPC polymer-applied hydrophilicized PTFE filter was pressed against the cut surface of the pipette tip to temporarily install the filter. In this state, the cut surface was pressed downward to a hot plate heated to 180° C. to perform heat fusion. This was used as a pipette tip of Production Example 11.

Using a micropipette, 100 μL of HT carrier particles (Bio-Gel HT Hydroxyapatite manufactured by Bio-Rad Laboratories, Inc., model number: 130-0150) adjusted to 50% slurry with PBS buffer was added into the pipette tip of Production Example 11 from the upper end of the pipette tip to obtain a pipette tip of Example 14.

An automatic pipettor (manufactured by GILSON, model number: P10mLM, for 10 mL) was connected to the upper end of the pipette tip of Example 14. Further, the lower end of the pipette tip was disposed in a U-bottom 50 mL tube (manufactured by Falcon Corporation, NO. 352070) containing 4 mL of the virus solution, and the solution in the tube was disposed to be sucked.

As a virus solution, an inactivated influenza virus obtained by inactivating cultured type-A influenza virus (109.0 TCID50/mL) by formalin (manufactured by FUJIFILM Wako Pure Chemical Corporation, model number: 060-03845) treatment was used. The inactivated virus was diluted 2 million times with 0.1% polyethylene glycol #6000 (manufactured by Nacalai Tesque Inc., model number: 28254-85)/D-PBS (−) (manufactured by FUJIFILM Wako Pure Chemical Corporation, model number: 045-29795) to prepare an inactivated virus solution. This virus solution was defined as Input.

In a custom mode of the automatic pipettor, the program of sucking 5.5 mL of solution at a speed of Speed 1, waiting for 5 seconds, discharging 5.5 ml of solution at a speed of Speed 1, and waiting for 20 seconds was run for 1 hour at room temperature to adsorb the virus to the HT carrier particles.

After repeating suction and discharge, the liquid in the pipette tip was discharged, and then the tube was replaced. Specifically, the tube containing the virus solution was removed (the remained solution was considered to have passed through), and a pipette tip was disposed such that the solution in a new tube containing 100 μL of Lysis buffer (5 M guanidine thiocyanate (manufactured by FUJIFILM Wako Pure Chemical Corporation, model number: 077-04995), 100 mM EDTA aqueous solution (pH 8.0, manufactured by Nippon Gene Co., Ltd., model number: 311-90075), and 100 mM Tris-HCl (pH 6.8): Tris (manufactured by FUJIFILM Wako Pure Chemical Corporation, model number: 200-07887), which were pH-adjusted with hydrochloric acid (manufactured by FUJIFILM Wako Pure Chemical Corporation, model number: 080-01066), 3% Triton X-100 (Nacalai Tesque Inc., 35501-15), 1% 2-mercaptoethanol (manufactured by Sigma-Aldrich Co. LLC, model number: M3148) could be sucked.

In a custom mode of the automatic pipettor, the program of sucking 2 mL of solution at a speed of Speed 1, waiting for 5 seconds, discharging 2 mL of solution at a speed of Speed 1, and waiting for 5 seconds was run for 10 minutes at room temperature to destroy the virus adsorbed to the HT carrier particles, and release the contained nucleic acid, and this recovered liquid was defined as Elute.

100 μL of purified water was added to 100 μL of Elute, and a total of 200 μL of the liquid was subjected to an automated nucleic acid extraction device (manufactured by Precision System Science Co., Ltd., magLEAD 12gC), and nucleic acids including viral RNA were extracted using a nucleic acid extraction reagent (manufactured by Precision System Science Co., Ltd., MagDEA Dx SV).

For Input and Through, 100 μL of Lysis buffer was added to 100 μL of Input and Through, and a nucleic acid containing viral RNA was extracted in the same manner as described above.

Quantitative PCR for M gene of influenza A virus, which is an example of a gene unique to influenza A virus, was performed using Input, Through, and Elute as PCR samples. Quantitative PCR was performed using primers and probes (MP-39-67For, MP-183-153Rev, and MP-96-75ProbeAs) for detecting the M gene of influenza A virus shown by Nakauchi et al. (Journal of Virological Methods, 2011, One-step real-time reverse transcription-PCR assays for detecting and subtyping pandemic influenza A/H1N1 2009, seasonal influenza A/H1N1, and seasonal influenza A/H3N2 viruses), a commercially available quantitative PCR kit (manufactured by TOYOBO Co., Ltd., THUNDERBIRD Probe One-step qRT-PCR Kit), and a quantitative PCR apparatus (7500 Fast Real-Time PCR System manufactured by Applied Biosystems). The experiment was carried out with n=2.

In each step of adsorption, cleaning, and elution, dispersion of the carrier (a state where the carrier was stirred up) associated with the suction/discharge operation was visually observed.

In the pipette tip of Example 14 (inclination angle of 55°), when the carrier was stirred up in the solution along with the suction of the solution, strong swirling of the carriers was clearly observed, and it was considered that a turbulent flow occurred along with the suction of the solution. The carrier precipitated in the solution along with the discharge of the solution and accumulated on the filter to uniformly cover the entire surface of the filter. However, after the discharge, the position of the carrier on the filter changed toward the lowermost end of the pipette tip due to gravity until the next suction, and the carrier covered only a part of the filter surface.

The results (amplification curves in quantitative PCR) are shown in FIG. 18. The vertical axis of the graph represents ΔRn (intensity of a fluorescence signal generated under a predetermined PCR condition), and the horizontal axis represents the number of cycles in quantitative PCR.

In addition to ΔRn when Input, Through, and Elute were used as PCR samples, ideal values at the time of concentration were shown. The ideal value at the time of concentration was calculated by preparing an influenza A virus solution which was 40 times thicker than Input, extracting nucleic acids containing viral RNA from the solution in the same manner as described above, and using the obtained solution as a PCR sample.

In Elute, ΔRn increased with fewer cycles than in Input, and it was revealed that a large amount of M gene was contained. That is, it was possible to produce a concentrated solution (Elute) having increased concentration of viral RNA which is the substance α from the virus solution (sample solution containing the substance β). For example, at ΔRn=0.1, the Ct value (32.5) of Elute was about 3.5 smaller than that of Input (36.0), and thus it was revealed that the concentration of viral RNA was increased by about 11.3 (23.5) times. In addition, in Elute, the amplification curve was close to the ideal value at the time of concentration.

### Experimental Example 11

In recent years, automation of an experimental protocol has been required in order to minimize variations in experimental data and human errors in manual multi-specimen processing. Therefore, a pipette tip with a filter applied to an automatic protein purification apparatus (Purelumn system) manufactured by Precision System Science Co., Ltd. was produced, and the immunoglobulin G from the human serum was purified.

The main body of the pipette tip (manufactured by Precision System Science Co., Ltd., 1.25 mL) was cut at a position of 17 mm from the lower end using a rotation sander. At this time, the inclination angle of the cut surface was set to 60° with respect to a line orthogonal to the axis of the pipette tip in a front view of the pipette tip. The MPC polymer-applied hydrophilicized PTFE filter was pressed against the cut surface of the pipette tip to temporarily install the filter. In this state, the cut surface was pressed downward to a hot plate heated to 180° C. to perform heat fusion. This was used as a pipette tip of Production Example 12.

Using a micropipette, 10 μL of Protein G Sepharose 4 Fast Flow (manufactured by Cytiva, model number: 71708300) was added into the pipette tip of Production Example 12 from the upper end of the pipette tip to obtain a pipette tip of Example 15.

The pipette tip of Example 15 was installed at the tip arrangement place of the Purelumn system, 400 μL of PBS (manufactured by TakaRa Bio Inc., model number: T900), to which Wash Buffer (1MNaCl (manufactured by FUJIFILM Wako Pure Chemical Corporation, model number: 191-01665) was added, was set to well 0, well 1, well 2, well 3, and well 4 of the GC Cartridge, 200 μL of human serum (manufactured by Cosmo Bio Co., Ltd., #12181201, lot: BJ14005+BJ14012) diluted 400 times with PBS (manufactured by TakaRa Bio Inc., model number: T900) containing 0.5% Triton X-100 (manufactured by Nacalai Tesque, Inc., model number: 35501-15) was set to the sample well, and 100 mM of glycine (manufactured by FUJIFILM Wako Pure Chemical Corporation, model number: 077-00735) and 200 μL of HCl (manufactured by FUJIFILM Wako Pure Chemical Corporation, model number: 080-01066) with pH2.5 were set to the Elute well.

As a working protocol, the pipette tip of Example 15 was sucked and discharged once in each of well 0 and well 1, and then sucked and discharged for 30 minutes in a sample well to bind immunoglobulin G in human serum to Protein G Sepharose. Subsequently, suction and discharge were performed five times in each of well 2, well 3, and well 4, and a non-specific binding component to Protein G Sepharose was cleaned. Finally, suction and discharge were performed with an Elute well for 100 seconds to elute the immunoglobulin G bound to Protein G. After recovery of the eluate, 20 μL of a neutralization buffer (1M Tris-HCl, pH 8.0) (manufactured by Nippon Gene Co. Ltd., model number: 314-90065) was added to neutralize the eluate.

3 μL of the eluate and 3 μL of each of human serum before purification (Input) and human serum after purification (Through) as a comparative control were mixed with a sample buffer (manufactured by FUJIFILM Wako Pure Chemical Corporation, #196-16142), treated at 100° C. for 5 minutes, and then developed by SDS-PAGE. As a gel for SDS-PAGE, SuperSep™ Ace, 10 to 20% (manufactured by FUJIFILM Wako Pure Chemical Corporation, #191-15031) was used. As a molecular weight marker serving as a control of the molecular weight of the protein, Precision Plus Protein 2 color standard (manufactured by Bio-Rad Laboratories, Inc., model number: 1610374) was used. After electrophoresis, the developed gel was stained with silver using EzStain Silver (manufactured by ATTO Corporation, model number: 2332360) to visualize proteins contained in the solution.

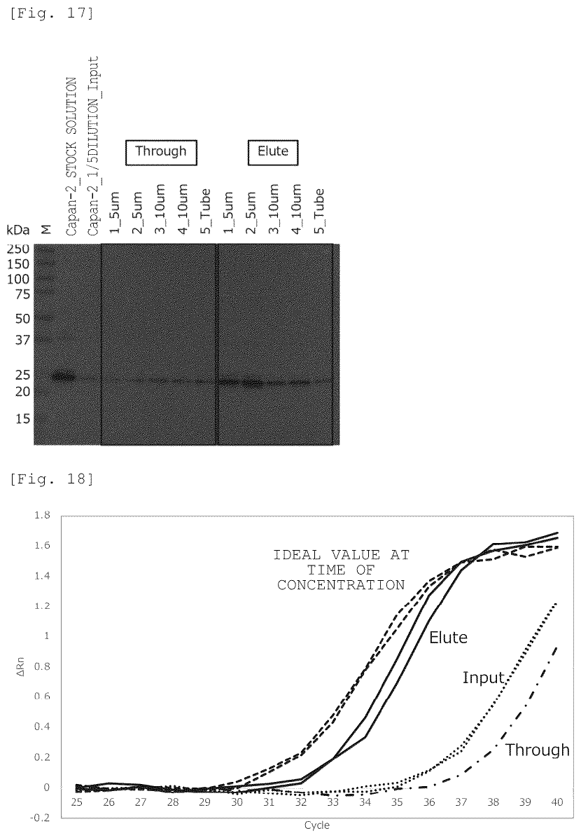

The results are shown in FIG. 19. In human serum (Input) before purification, numerous protein bands contained in the serum are confirmed, and among them, protein bands corresponding to immunoglobulin G are present at about 50 KDa and 25 KDa. As a result of purification with the pipette tip of Example 15, it was confirmed that bands of 50 KDa and 25 KDa were removed from human serum (Through) after purification, and bands of 50 KDa and 25 KDa existed as main components in the eluate.

From human serum containing immunoglobulin G, a concentrated solution having increased concentration of immunoglobulin G could be produced.

### Experimental Example 12

The monoclonal antibody was purified from the hybridoma culture solution using a Purelumn system (manufactured by Precision System Science Co., Ltd.) and a pipette tip with a filter.

As a hybridoma cell producing a monoclonal antibody, CP12 cells (Anal. Chem. 94, 2476-2484, 2022) were used. For maintenance culture of hybridoma cells, a 6-well dish (manufactured by Falcon Corporation, 353046) and a serum-containing medium (RPMI-1640 medium (manufactured by FUJIFILM Wako Pure Chemical Corporation, #183-02023), 10% Fetal Bovine Serum (manufactured by Thermo Fisher Scientific Inc. (Gibco), #10270106), and 1% Penicillin-Streptomycin (manufactured by Thermo Fisher Scientific Inc. (Gibco), #15140122)) were used at 37° C. and a 5% CO₂ concentration.

The monoclonal antibody was produced in a serum-containing medium in which the concentration of Fetal Bovine Serum (manufactured by Thermo Fisher Scientific Inc. (Gibco), #10270106) was changed to 0.5% in a 6-well dish (manufactured by Falcon Corporation. 353046). 5×10⁵ hybridoma cells were suspended in 2 mL of 0.5% serum medium, and after 48 hours and 96 hours, the culture solution was recovered, and centrifuged at 2,000×G for 10 minutes using a centrifuge (manufactured by TOMY SEIKO CO., LTD., LX-130), and the hybridoma cells and debris generated during culture were removed to obtain a sample to be used for purification (Input). The culture solution after 96 hours was also directly purified from a sample not subjected to a centrifugation operation (without centrifugation).

Using a micropipette, 20 μL of rProtein A Sepharose Fast Flow (manufactured by Cytiva, model number: 17127901) was added into the pipette tip of Production Example 12 from the upper end of the pipette tip to obtain a pipette tip of Example 16.

The pipette tip of Example 16 was installed at the tip arrangement place of the Purelumn system, 1 mL of Wash Buffer (PBS (manufactured by TakaRa Bio Inc., model number: T900)) was set to well 0, well 1, well 2, well 3, and well 4 of the GC Cartridge, 1 mL of culture supernatant was set to the sample well, and 100 mM of glycine (manufactured by FUJIFILM Wako Pure Chemical Corporation, model number: 077-00735) and 50 μL of HCl (manufactured by FUJIFILM Wako Pure Chemical Corporation, model number: 080-01066) with pH2.5 were set to the Elute well.

As a working protocol, the pipette tip of Example 16 was sucked and discharged once in each of well 0 and well 1, and then sucked and discharged for 60 minutes in a sample well to bind the monoclonal antibody in the culture supernatant sample to rProtein A Sepharose. Subsequently, suction and discharge were performed five times in each of well 2, well 3, and well 4, and a non-specific binding component to rProtein A Sepharose was cleaned. Finally, suction and discharge was performed for 100 seconds in an Elute well to elute the monoclonal antibody bound to rProtein A. After recovery of the eluate, 5 μL of a neutralization buffer (1M Tris-HCl, pH 8.0) (manufactured by Nippon Gene Co. Ltd., model number: 314-90065) was added to neutralize the eluate.

9 μL of the eluate and 9 μL of each of culture supernatant before purification (Input) and culture supernatant after purification (Through) as a comparative control were mixed with a sample buffer (manufactured by FUJIFILM Wako Pure Chemical Corporation, #196-16142), treated at 100° C. for 5 minutes, and then developed by SDS-PAGE. As a gel for SDS-PAGE, XV PANTERA LL Gel, 10%, 16 well (manufactured by D.R.C. Co., Ltd., #DLL-225P) was used. As a molecular weight marker of protein, Precision Plus Protein 2 color standard (manufactured by Bio-Rad Laboratories, Inc., model number: 1610374) was used. After electrophoresis, the developed gel visualized the proteins separated in the gel by the Coomassie Brilliant Blue staining method using a CBB staining solution (manufactured by BIO CRAFT, model number CBB-1000).

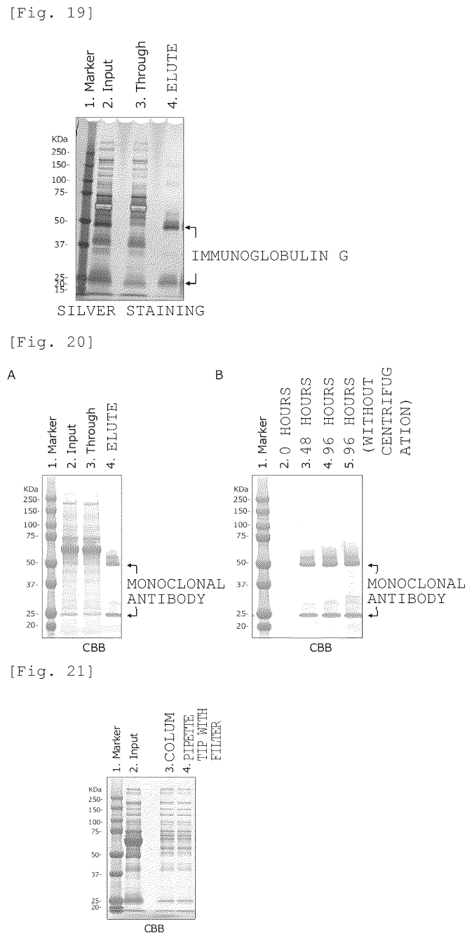

The results of using the culture solution subjected to centrifugal separation for 48 hours are shown in FIG. 20A. In the culture supernatant (Input) before purification, numerous protein bands contained in the serum-containing medium were confirmed, but as a result of purification with the pipette tip of Example 16, bands derived from the monoclonal antibody were confirmed at positions of about 50 KDa and 25 KDa in the eluate. These bands were present in Input before purification, but almost disappeared in Through after purification, and it was revealed that the monoclonal antibody was specifically purified by the pipette tip operation of Example 16.

FIG. 20B illustrates the results of using the centrifuged culture solutions for 0 hour, 48 hours, and 96 hours and the results of using the culture solution for 96 hours in which centrifugation is not performed. In the cases of 48 hours and 96 hours, it was found that more monoclonal antibodies could be purified in the case of 96 hours. That is, it was possible to monitor the production amount of the monoclonal antibody in a culture time-dependent manner. In addition, the culture solution for 96 hours in which centrifugation is not performed is a sample containing hybridoma cells and cultured debris, but even in the case of using this, it was possible to purify the monoclonal antibody in the same amount as in the case of the centrifugation operation. From these results, by using the pipette tip of Example 16, it is possible to monitor the production amount of the monoclonal antibody during culture of the hybridoma cells without performing any centrifugation operation.

From the hybridoma culture solution, a concentrated solution having increased concentration of the monoclonal antibody could be produced.

### Experimental Example 13

Next, pretreatment of protein analysis using a pipette tip with a filter was examined. There are numerous proteins in human serum, and it is known that about 12 major proteins account for 95% of them. For highly sensitive analysis of trace amount of proteins in serum using such as a mass spectrometer, pretreatment for removing them in advance is required, and reagents therefor are commercially available. For example, Proteome Purity 12 Human Serum Protein Immunodepletion Resin solution (manufactured by R&D Systems, model number: IDR012-020) is a carrier that removes major proteins, specifically, α1-acid glycoprotein, α1-antitrypsin, α2-macroglobulin, albumin, apolipoprotein A-I, apolipoprotein A-II, fibrinogen, haptoglobulin, IgA, IgG, IgM, and transferrin from human serum or human plasma.

Automatic pretreatment of the protein analysis samples was performed using the pipette tip with a filter and the Purelumn system.

Using a micropipette, 100 μL of a Proteome Purity 12 Human Serum Protein Immunodepletion Resin solution (manufactured by R&D Systems, model number: IDR012-020) was added into the pipette tip of Production Example 12 from the upper end of the pipette tip to obtain a pipette tip of Example 17.

The pipette tip of Example 17 was installed at the tip arrangement place of the Purelumn system, and 100 μL of human serum (manufactured by Cosmo Bio Co., Ltd., #12181201, lot: BJ14005+BJ14012) diluted 100 times with PBS (manufactured by TakaRa Bio Inc., model number: T900) containing 0.5% Triton X-100 (manufactured by Nacalai Tesque, Inc., model number: 35501-15) was set to the sample well.

The pipette tip of Example 17 was sucked to and discharged from a sample well for 30 minutes to allow binding of major proteins in human serum to Proteome Purity 12 Human Serum Protein Immunodepletion Resin (manufactured by R&D System, model number: IDR012-020). The sample solution was recovered from the sample well after suction and discharge.

As a control of the experiment using the pipette tip of Example 17, removal of serum major proteins using the column was performed. Using a micropipette, 100 μL of Proteome Purity 12 Human Serum Protein Immunodepletion Resin solution (manufactured by R&D Systems, model number: IDR012-020) was added to a column (manufactured by Bio-Rad Laboratories, model number 7326304). The mixture was centrifuged at 1,000×G for 10 seconds in a micro centrifuge (manufactured by TOMY Lab Equipment, model number: MX-300), the solvent of resin was removed, then 100 μL of human serum (manufactured by Cosmo Bio Co., Ltd., #12181201, lot: BJ14005+BJ14012) diluted 100 times with PBS (manufactured by TakaRa Bio Inc., model number: T900) containing 0.5% Triton X-100 (manufactured by Nacalai Tesque, Inc., model number: 35501-15) was added, and the mixture was mixed by inversion at room temperature for 30 minutes with BugCrasherGM-01 (manufactured by TAITEC CORPORATION) to which a column cap was attached. Centrifugation was performed at 1,000×G for 10 seconds in a micro centrifuge (manufactured by TOMY Lab Equipment, model number: MX-300), and the Through liquid was recovered.

10 μL of the sample solution after being sucked and discharged for 30 minutes with the pipette tip of Example 17 and 10 μL of the Through solution treated for 30 minutes with the column were mixed with a sample buffer (manufactured by FUJIFILM Wako Pure Chemical Corporation, #196-16142), treated at 100° C. for 5 minutes, and developed by SDS-PAGE. As a gel for SDS-PAGE, XV PANTERA LL Gel, 10%, 16 well (manufactured by D.R.C. Co., Ltd., #DLL-225P) was used. As a molecular weight marker of protein, Precision Plus Protein 2 color standard (manufactured by Bio-Rad Laboratories, Inc., model number: 1610374) was used. After electrophoresis, the developed gel visualized the proteins separated in the gel by the Coomassie Brilliant Blue staining method using a CBB staining solution (manufactured by BIO CRAFT, model number CBB-1000).

The results are shown in FIG. 21. Numerous protein bands contained in serum were confirmed in human serum (Input) before treatment, but it was confirmed that some proteins present in a large amount were removed in a sample (column, pipette tip with filter) treated with Proteome Purity 12 Human Serum Protein Immunodepletion Resin (manufactured by R&D Systems, model number: IDR012-020). In addition, in a case where a column was manually used and in a case where a pipette tip with a filter was used by an automatic machine (Purelumn System, Precision System Science Co., Ltd.), a similar protein removing effect was recognized. However, in a case where processing of six samples was performed, processing in a time of ⅔ to half or less was possible in a case where the automatic machine and the pipette tip with a filter were used.

From human serum, it was possible to produce a purified solution in which purity of proteins other than the main protein (α1-acid glycoprotein, α1-antitrypsin, α2-macroglobulin, albumin, apolipoprotein A-I, apolipoprotein A-II, fibrinogen, haptoglobulin, IgA, IgG, IgM, and transferrin) in serum is increased.

The pipette tip with a filter and the carrier used in the above Examples are as follows.

TABLE 2

| | | Inclination angle of | |
|---|---|---|---|
| | | cut surface (In a | |
| | | front view of pipette | |
| | | tip, an angle made by | |
| | | the cut surface and | |
| | Used pipette | the line orthogonal to | |
| | tip with | the axis of | |
| | a filter | pipette tip) | Carrier |
| Example 1 | Production | 65° | HT Hydroxyapatite |
| | Example 6 | | |
| Example 2 | Production | 10° | HT Hydroxyapatite |
| | Example 1 | | |
| Example 3 | Production | 20° | HT Hydroxyapatite |
| | Example 2 | | |
| Example 4 | Production | 40° | HT Hydroxyapatite |
| | Example 3 | | |
| Example 5 | Production | 60° | HT Hydroxyapatite |
| | Example 5 | | |
| Example 6 | Production | 70° | HT Hydroxyapatite |
| | Example 7 | | |
| Example 7 | Production | 55° (V shape) | SA-Mag Sepharose |
| | Example 8 | | |
| Example 8 | Production | 40° | SA-Tim4-Mag |
| | Example 3 | | Sepharose |
| Example 9 | Production | 60° | SA-Tim4-Mag |
| | Example 5 | | Sepharose |
| Example 10 | Production | 70° | SA-Tim4-Mag |
| | Example 7 | | Sepharose |
| Example 11 | Production | 50° | SA-Tim4-Mag |
| | Example 4 | | Sepharose |
| Example 12 | Production | 50° | SA-Tim4-Mag |
| | Example 9 | | Sepharose |
| Example 13 | Production | 50° | SA-Tim4-Mag |
| | Example 10 | | Sepharose |
| Example 14 | Production | 55° | HT Hydroxyapatite |
| | Example 11 | | |
| Example 15 | Production | 60° | Protein G |
| | Example 12 | | Sepharose |
| Example 16 | Production | 60° | rProtein A |
| | Example 12 | | Sepharose |
| Example 17 | Production | 60° | Proteome Purity 12 |
| | Example 12 | | Human Serum |
| | | | Protein |
| | | | Immunodepletion |
| | | | Resin |

What is claimed is:

1. A pipette tip comprising:
a tip main body that stores liquid; and
a filter disposed in a lower opening portion of a lower end of the tip main body, wherein
an inclined portion is provided in at least a part of the lower opening portion in which the filter of the lower end of the tip main body is disposed, and
a carrier is held in the tip main body.

2. The pipette tip according to claim 1, wherein an inclination angle of the inclined portion is greater than 20° and 70° or less with respect to a line orthogonal to an axis of the pipette tip in a front view of the pipette tip.

3. The pipette tip according to claim 1, wherein the carrier is hydroxyapatite or a magnetic carrier.

4. The pipette tip according to claim 1, wherein a material constituting the filter is polytetrafluoroethylene (PTFE) or polyvinylidene fluoride (PVDF).

5. The pipette tip according to claim 1, wherein a melting point of a material constituting the filter is higher than a melting point of a material constituting the tip main body, and the filter is fused to the lower opening portion.

6. The pipette tip according to claim 1 for producing a concentrated solution having increased concentration of a substance α from a sample solution containing a target substance (substance α) or a substance α-containing substance (substance β).

7. A method for producing a concentrated solution having increased concentration of a substance α from a sample solution containing a target substance (substance α) or a substance α-containing substance (substance β) using the pipette tip according to claim 1, the method comprising:
a step A of sucking and discharging the sample solution through a lower opening portion of a lower end of the pipette tip to adsorb the substance α or the substance β to the carrier; and
a step B of sucking and discharging a releasing solution to release the substance α from the carrier, thereby obtaining a concentrated solution having increased concentration of the substance α.
